(19) United States
(12) Patent Application Publication
(10) Pub. No.: US 2020/0352190 A1
(43) Pub. Date: Nov. 12, 2020

(54) NON-DAIRY FERMENTED WATER KEFIR BASE COMPOSITION AND METHODS OF MAKING AND USING THE SAME

(71) Applicant: THE QUAKER OATS COMPANY, Chicago, IL (US)

(72) Inventors: Michelle JOHNSON, West Dundee, IL (US); Sundar BALA, Arlington Heights, IL (US); Kris SUBRAMANIAN, Vernon Hills, IL (US); Valerie SERSHON, Schaumburg, IL (US); Jin-E SHIN, Hoffman Estates, IL (US); Geoffrey PFEIFER, Ojai, CA (US)

(21) Appl. No.: 16/406,843

(22) Filed: May 8, 2019

(51) Int. Cl. A23C 11/02; A23L 33/10; C12J 1/08

(52) U.S. Cl. CPC A23C 11/02; A23V 2002/00; C12J 1/08; A23L 33/10

(57) ABSTRACT

The present disclosure relates to a non-dairy fermented water kefir base composition and methods of making and/or using the non-dairy fermented water kefir base composition to produce nutritional products, such as food and beverage products.

### FIELD OF THE PRESENT DISCLOSURE

The present disclosure relates to a non-dairy fermented water kefir base composition and methods of making and/or using the non-dairy fermented water kefir base composition to produce nutritional products, such as food and/or beverage products.

### BACKGROUND

Milk kefir is produced from fermented milk or dairy products inoculated with a yeast and/or bacterial culture of kefir grains. Typically, milk kefir is fermented at ambient temperatures for 12-24 hours (e.g., overnight). Fermentation of lactose, the sugar present in milk or other dairy products, provides a sour, carbonated composition with a consistency similar to yogurt. The resulting milk kefir dairy composition may be used as the basis for a food or beverage product.

Unlike milk kefir, water kefir does not require milk and/or any dairy products at all. Instead, water kefir is produced by fermenting water kefir grains, also called water kefir crystals. Water kefir grains are made from kefir grains, also called sugar kefir grains, tibicos, tibi, Japanese water crystals, and California bees. Kefir grains are self-propagating grains often comprising a symbiotic culture of bacteria and/or yeasts (SCOBY). The microbes (e.g., bacteria and/or yeast) of the kefir grains create matrices that contain the SCOBY, which act in symbiosis to establish and maintain a stable microbial culture.

Often, water kefir grains are placed in liquid mediums comprising sugar, such as sugar water, to initiate growth of a new culture. The SCOBY of the water kefir grains metabolize the sugar in the water to produce alcohols, such as ethanol. Carbon dioxide is also produced during the metabolic processing of sugar by the SCOBY of the water kefir grains. Such carbonation of the culture may be visually identified by the production of “bubbles” in the medium. This microbial culture, base liquid, or fermentation byproduct may then be utilized as a base ingredient in order to produce nutritional products, such as commercial food and/or beverage products.

While water kefir grains are currently used in the art to produce non-dairy food and beverage products, the fermentation process of making or producing such non-dairy fermented base products is time consuming (e.g., may require an extra filtration step to remove live yeast), requires expensive ingredients, and often, is not tightly controlled. Moreover the process is prone and highly susceptible to contamination from the live yeast and/or bacteria handled during fermentation. Therefore, a need exists for new and improved methods and processes for fermenting water kefir grains that are capable of producing a non-dairy water kefir base composition, which may subsequently be used to generate food and beverage products with improved nutritional, sensory, flavor, and/or texture characteristics that are advantageous for commercial retail.

### SUMMARY OF THE INVENTION

The present disclosure provides a non-dairy fermented water kefir base composition. The non-dairy fermented water kefir base composition of the present disclosure may comprise: a) a mash, b) a starter culture, c) a medium, and d) an organic acid. The starter culture of the base composition comprises live yeast, live bacteria, or combinations thereof. In one embodiment, the starter culture of the base composition comprises live bacteria only.

The medium of the base composition may be a liquid medium. The liquid medium may be water. The water medium may further comprise a source for carbon, nitrogen, or minerals.

The organic acid of the base composition may be selected from the group consisting of acetic acid, lactic acid, citric acid, fumaric acid, phosphoric acid, malic acid, oxalic acid, ascorbic acid, and combinations thereof. The acetic acid of the base composition may be in the form of apple cider vinegar (ACV). The base composition may comprise about 0.1% to about 6% of ACV in the base composition.

The mash of the present disclosure comprises a composition or component selected from the group consisting of water, a sugar source, a mineral blend, and one or more enhancers. The one or more enhancers are selected from the group consisting of a flavoring agent, a yeast extract, a fruit syrup, an herb or botanical extract, and a salt

The present disclosure is also related to a nutritional product comprising the non-dairy fermented water kefir base composition. The nutritional product may be a food, a snack, an elixir, a shot, a shooter, a spoonable, a smoothie, a shake, a soup, or a beverage.

The present disclosure is also related to a method of making or producing the described non-dairy fermented water kefir base composition. The method of making or producing the base composition may comprise: a) mixing a starter culture and a medium to form a mixture, b) fermenting the mixture to produce an amount of lactic acid, c) adding an organic acid that is not a lactic acid to the mixture at a pH ranging from about 3.5 to about 4.2 and the titratable acidity increases, and d) producing the non-dairy fermented water kefir base composition. In this method of making or producing the base composition, addition of the organic acid that is not lactic acid also increases the titratable acidity of the base composition by 50-200% when compared to the existing method of production.

Finally, the present disclosure is directed to a method of fermenting the described non-dairy water kefir base composition. The method of fermenting the base composition may comprise: a) mixing a starter culture and a medium to form a mixture, b) producing an amount of lactic acid from the mixture until the pH ranges from about 3.5 to about 4.2, c) cooling the reaction to stop production of the lactic acid, and d) adding the acid that is not lactic acid to the mixture so that the pH ranges from about 3.0 to about 3.6. In this method of fermenting the base composition, addition of the organic acid that is not lactic acid also increases the titratable acidity of the base composition by 50-200% when compared to the existing method of production.

### BRIEF DESCRIPTION OF THE DRAWINGS

The detailed description particularly refers to the accompanying figures as described below.

FIG. 1 is a schematic that shows one general embodiment of the present methods of making, producing, and/or fermenting the base composition.

FIG. 2 is a schematic that shows one specific embodiment of the present methods of making, producing, and/or fermenting the base composition.

FIG. 3 is a graph that shows the pH of base compositions that do and do not include apple cider vinegar (ACV) during storage for a shelf life of about 8 weeks.

FIG. 4 is a graph that shows the Brix levels of base compositions that do and do not include apple cider vinegar (ACV) during storage for a shelf life of about 8 weeks.

FIG. 5A is a graph that shows the nutritional profile (i.e., °Bx, % Total Sugar, and % Available CHO) for the base composition after a time period of zero (0) weeks, about 4 weeks, and about 8 weeks.

FIG. 5B is a graph that shows the mineral content for the base composition at pH 3.5 after a time period of zero (0) weeks, about 4 weeks, and about 8 weeks.

FIG. 5C is a graph that shows the nutritional profile (i.e., oBx) for the base composition after a time period of zero (0) weeks, about 4 weeks, and about 8 weeks.

FIG. 6 is a graph that shows the overall degree of difference (DOD) rating of the base compositions that do and do not include apple cider vinegar (ACV) as compared to frozen control compositions that are maintained at a pH of about 3.5 to about 4.0 during storage for about 8 weeks.

FIG. 7 is a graph that shows the differences in product attributes between the base composition as compared to frozen control compositions during storage for about 8 weeks.

FIG. 8A is a graph that shows the change in pH of unpasteurized base compositions based on storage at different temperatures.

FIG. 8B is a graph that shows the change in pH of pasteurized base compositions based on storage at different temperatures.

FIG. 9 is a dot plot and bar graph that show the 75-100 hour fermentation time required to reduce the pH of the base composition to less than 3.5 without the addition of lactic acid and/or acetic acid.

FIG. 10 is a graph that shows the time required to reduce the pH of the base composition to about 4.0 with the addition of lactic acid and/or acetic acid to 2L and 50 gallon fermenters.

### DETAILED DESCRIPTION

### Definitions

The phrase “and/or” refers to the inclusion of several embodiments described or implied in the present disclosure comprising one of the described components, compositions, agents, or steps of the embodiment; all of the components, compositions, agents, or steps of the embodiment; or a combination of one or more of the components, compositions, agents, or steps of the embodiment of the invention of the present disclosure.

“Anaerobic” conditions of the present disclosure refer to an environment and/or an atmosphere where about 20% to about 21% or less of free oxygen (i.e., O2) is present, although other forms of oxygen may be present in the same environment and/or atmosphere. Anaerobic conditions are present when no free oxygen (i.e., about 0% O2) is present.

As used in the present disclosure, the phrase “apple cider vinegar” refers to fermented juice from the sugar of apples, like crushed apples. Typically, apple cider vinegar is produced by adding “live yeast” and/or “live bacteria” to apple juice in order to ferment the sugars in the apple juice to produce alcohol. The fermented alcohol (e.g., ethanol) is then metabolized via a second fermentation process comprising acetic-acid forming bacteria (e.g., Acetobacter) to convert the ethanol into acetic acid, thus producing apple cider vinegar. Often, apple cider vinegar contains other components, such as pectin, vitamins (e.g., B1, B2, B6, and/or C), biotin, folic acid, niacin, pantothenic acid, as well as minerals, including, but not limited to sodium, phosphorous, potassium, calcium, iron, and magnesium.

Degrees of “Brix” refer to the sugar content of a solution, such as an aqueous solution. One degree Brix (1°Bx) equals 1 gram (g) of sugar (e.g., sucrose, glucose, dextrose, and/or fructose) in 100 g of solution. Thus, the term “Brix” refers to the strength of the sugar content in a solution as a percentage of mass. If the solution contains dissolved solids other than pure sugar (e.g., sucrose, glucose, dextrose, and/or fructose), then the unit “Brix” refers to the approximate amount of dissolved solid content in the solution.

The terms “composition” or “compositions” refer to one or more compounds, components, or agents with or without the addition of another compound, component, or agent, making the composition especially suitable for use as a food or a beverage product.

The terms “component” or “components” refer to a constituent part of a composition. For example, components of a composition of the present disclosure can include one or more chemical compounds, cells and/or cell cultures (e.g., live yeast and/or live bacteria), ingredients (e.g.,. a food or beverage ingredient), and/or any other agent present in the composition. Additional components of the composition of the present disclosure may include, but are not limited to, flavorings, surfactants, adjuvants, excipients, dispersants, emulsifiers, additives, etc.

A “combination” refers to a joining of one or more compounds, components, agents, and/or compositions to another compound, component, agent, and/or composition or to a plurality of compounds, components, agents, and/or compositions. The “combination” may comprise, consist essentially of, or consist of cells and/or cell cultures (e.g., live yeast and/or live bacteria), compounds, compositions, components, constituents, elements, moieties, molecules, or mixtures. A combination includes, but is not limited to, a mixture.

The term “comprising” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

The term “elixir” refers to a composition that may provide some medicinal and/or curative effect to any symptom or sign of a disease, a disorder, or an ailment of a subject. An “elixir” of the present disclosure is generally in the form of a food, snack, and/or beverage product. An illustrative “elixir” is a beverage product comprising the non-dairy fermented water kefir base composition of the present disclosure.

The terms or phrases “effect,” “effective,” and “effective amount” refer to the amount of a composition, component, and/or compound sufficient to provide beneficial or desired results. An effective amount of any composition and/or component of the present disclosure may be administered via ingestion of a food and/or beverage product comprising the non-dairy fermented water kefir base composition of the present disclosure.

The phrases “live yeast” and/or “live bacteria” refer to one or more different cultures of yeast and/or bacterial strains that are alive (i.e., living) and able to reproduce to quantities significant enough to form, establish, and maintain a larger microbial culture. Cultures of “live yeast” and/or “live bacteria” of the present disclosure, include, but are not limited to a symbiotic colony of bacteria and yeast (SCOBY), which may be commercially purchased or privately cultured. “Live yeast” and/or “live bacteria” cell cultures may be purchased at commercial manufacturers, including, but not limited to American Type Culture Collection (ATCC), Chr. Hansen, DuPont, Lallemond, etc.

The phrase “non-dairy” refers to a composition that contains little or no amount or concentration of a dairy component, which may include, but is not limited to, milk (including buttermilk, powdered milk, evaporated milk, and any percentage of whole milk, such as 1% or 2% milk), cheese (including cottage cheese and cheese sauces), butter and butter fat, cream (including sour cream), yogurt, ice cream, and/or pudding. Illustrative dairy proteins and dairy allergens that should not be present or should be maintained in limited quantities and/or concentrations in the “non-dairy” composition of the present disclosure include, but are not limited to casein or caseinates, curd, ghee, hydrolysates, lactalalbumin and lactalbumin phosphate, lactose, lactoglobulin, lactoferrin, and lactulose, rennet, whey, and whey products.

A “starter culture” of the “live yeast” and/or “live bacteria” of the present disclosure may comprise a range of about 1×105 to about 1×108 CFU/g (colony forming units per gram) of active units of “live yeast” and/or “live bacteria.” Preferably the starter culture comprises of about 5×105 to about 5×106 CFU/g of active units of culture.

In particular, the usage of the starter culture comprising “live yeast” and/or “live bacteria” may be at a rate ranging from about 0.01% to about 0.05% of starter culture (at a strength/concentration of about 1×105 to about 1×108 CFU/g) per liter of medium. This equates to 500 g of starter culture (at a strength/concentration of about 1×105 to about 1×108 CFU/g) for 5000 L of medium or 1 gram of starter culture (at a strength/concentration of about 1×105 to about 1×108 CFU/g) for 10 L of medium.

Typically, a starter culture comprises active units of one or more different strains of “live yeast” and/or “live bacteria.” For example, a starter culture may comprise 1 to 100 different strains of “live yeast” and/or “live bacteria.” Generally, the starter culture comprises, consists essentially of, or consists of about 2 to about 20 strains, from about 3 to about 7 strains, from about 4 to about 6 strains, and at or about 5 strains of different “live yeast” and/or “live bacteria.” Often, a culture or “starter culture” of “live yeasts” and/or “live bacteria” (e.g., SCOBY) may be grown or commercially purchased in the presence of an allergen-free base, such as a dairy allergen-free base composition.

The term “base” or the phrases “base ingredient” or “base composition” refer to a composition produced when a “starter culture” has been inoculated into or onto a medium that provides the necessary nutrient-rich environment where the “live yeast” and/or “live bacteria” of the “starter culture” is processed and/or grown in order to result in a larger culture. The base composition of the present disclosure comprises, consists essentially of, or consists of the starter culture before or after the fermentation process (e.g., pre-fermentation or post-fermentation), as described herein. To produce the “base composition, the “starter culture” may be inoculated onto a solid medium or liquid medium. An illustrative solid medium may include a piece of fruit.

The medium upon which the “starter culture” is inoculated may also be a liquid, such as water. An illustrative liquid medium of the present disclosure is sugar water, juice, or syrup (e.g., fruit and/or vegetable juice or syrup). In one embodiment, the liquid medium may comprise, consist essentially of, or consist of a carbon source.

The carbon source of the liquid medium may include, but is not limited to a disaccharide sugar or a monosaccharide sugar. An illustrative disaccharide sugar of the present disclosure includes, but is not limited to sucrose. An illustrative monosaccharide sugar of the present disclosure includes, but is not limited to glucose, fructose, or combinations thereof.

In the same or a different embodiment as that comprising a carbon, the liquid medium of the may also comprise, consist essentially of, or consist of a nitrogen source. Illustrative embodiments of nitrogen sources of the present disclosure include, but are not limited to a form of nutritive yeast and/or a yeast extract.

In addition to the carbon and nitrogen sources, the starter culture of the present disclosure may further comprise a mineral source. An illustrative mineral source of the present disclosure includes, but is not limited to a form of nutritive minerals, such as crude minerals or refined minerals.

Once inoculated into the medium, the “starter culture” may be metabolized and/or processed, such as by the process of fermentation. Generally, “fermentation” refers to the general process by which microorganisms (e.g., yeast and/or bacteria) are grown on a growth medium. Fermentation typically occurs under “anaerobic conditions” in the environment and/or atmosphere, and often produces a specific chemical compound and/or product at the end of the process. Notably, fermentation of the “starter culture” of the present disclosure typically produces an exemplary “base composition” or “base ingredient” of the present disclosure.

In the present disclosure, the term “fermentation” generally refers to the metabolic process where carbohydrates, such as sugars, are metabolized by “live yeasts” and/or “live bacteria” and converted into acids, gases, and/or alcohols. For example, fermentation of sugar by “live yeasts” often results in the formation of alcohols, such as ethanol. “Live bacteria,” excluding heterofermentative “live bacteria,” are generally unable to metabolize sugars in a way that converts the sugars to ethanol. However, homofermentative “live bacteria” are able to convert sugar to acid, rather than alcohol, and may also be comprised in the “base composition” or “base ingredient” of the present disclosure. Illustrative acids produced by the homofermentative conversion of sugar by “live bacteria” include, but are not limited to lactic acid, acetic acid, gluconic acid, citric acid, succinic acid, and others.

While the process of fermenting kefir grains and cultures with “live yeasts” has been known and utilized in the art for years, the current process of fermenting kefir grains has proven difficult to standardize and/or replicate the amount or concentration of kefir grains in the base composition. In addition, the standard fermentation process of kefir grains makes it extremely challenging to control batch-to-batch and/or lot-to-lot production variation of the base composition, which is required for manufacturing and retail of commercial nutritional products, such as food and/or beverage products, comprising the base composition. However, the methods of making and using the non-dairy fermented water kefir base composition of the present disclosure provide the ability to control the process outcomes, including the exclusion of the use of water kefir grains, that are used to culture a base composition of the present disclosure as well as nutritional products (e.g., food and/or beverage products) comprising the base composition. Thus, in an exemplary embodiment of the present methods of making and using the non-dairy fermented water kefir base composition of the present disclosure, no (i.e., 0%) water kefir grains are used or employed.

“Optional” or “optionally” refers to a circumstance in which the subsequently described event or circumstance may or may not occur, and that the description includes instances where the event or circumstance occurs and instances in which it does not. “Optionally” is inclusive of embodiments in which the described condition(s) are present and embodiments in which the described condition(s) are not present.

The term “pasteurization” or “pasteurizing” refers to a process where a composition (e.g., the mash, base, food and/or beverage compositions of the present disclosure) are heat treated in order to eliminate and/or kill pathogenic microorganisms and other undesired organisms, including but not limited to bacteria, fungi, viruses, and/or yeast. Heat may be directly and/or indirectly applied to the composition via any heat source means sufficient to kill pathogens, including but not limited to a heater, a heat exchanger (e.g., a plate heat exchanger), hot water, steam, etc. Typically, pasteurizing a composition involves treating with heat such that the composition is sterilized and/or sanitized by logarithmically destroying and/or inactivating microbial organisms that contribute to spoilage and/or degradation. Therefore, pasteurizing a composition also comprises a thermal inactivation process that often helps to increase the shelf life and/or storage life of the treated composition or product.

The term “plurality” refers to one or more components, agents, and/or compositions of the present disclosure and may range up to an unlimited and/or unquantifiable number of the same components, agents, and/or compositions. A “plurality” may also refer to two or more or even three or more components, agents, and/or compositions and may range up to an unlimited and/or unquantifiable number of the same components, agents, and/or compositions.

The terms “shot” and “shooter” are interchangeable and refer to a small serving (e.g., about 2 to about 5 ounces) of a concentrated composition. For example, typically in the food industry, a “shot” refers to a small serving of a concentrated beverage, such as an alcoholic beverage.

The term “smoothie” refers to a blended beverage and/or spoonable composition that comprises a thick, smooth texture. Typically, a “smoothie” comprises ingredients, including, but not limited to fruits, vegetables, nuts, milk, yogurt, water, ice, juice, sweeteners, whey, herbal or nutritional supplements, and/or ice cream.

A “shake” refers to an embodiment of a “smoothie.” However, generally a “shake” comprises more sugar content, including more content of ice cream and flavorings, and less healthy or nutritional ingredients than a “smoothie.” Therefore, “shakes” are often considered to have less nutritional value than a “smoothie.” For example, typical flavors of a “shake” include vanilla, chocolate, caramel, or peanut butter. In addition, “shakes” generally have a higher protein content than “smoothies.”

The term “spoonable” refers to a composition that is able to be consumed with a spoon utensil. An illustrative embodiment of a “spoonable” composition of the present disclosure is a food, snack, and/or beverage product that is capable of and/or typically is eaten with a spoon utensil. Illustrative embodiments of a “spoonable” composition include, but are not limited to yogurt, pudding, ice cream, soups, etc.

The terms “sterilization,” “sanitization,” “sanitizing,” and/or “sterilizing” refer to the process of killing and/or eliminating microorganisms that are detrimental to the safe and long-term storage of the mash, base, food and/or beverage compositions of the present disclosure. In the present disclosure, the terms “sterilization,” “sanitization,” “sanitizing,” and/or “sterilizing” often refer to treatment of a composition via irradiation, such as with ultraviolet (UV) light treatment, or via a pasteurization process where compositions may be heat treated to eliminate microbial pathogens, such as bacteria, fungi, viruses, and/or yeast.

A “subject” of the present disclosure refers to a human or an animal. An illustrative “subject” of the present disclosure is a human. The exemplary “subject” of the present disclosure is a human.

### Compositions and Components of the Present Methods

The methods of the present disclosure are directed to making, producing, fermenting, and/or using a non-dairy fermented water kefir base composition to produce nutritional products, such as food and/or beverage products. Food and/or beverage products of the present disclosure may comprise, consist essentially of, or consist of the non-dairy fermented water kefir base composition of the present disclosure. The food and/or beverage products of the present disclosure may be used for private, commercial, and/or retail sale.

The methods of the present disclosure comprise, consist essentially of, or consist of a non-dairy fermented water kefir base composition (“the base composition”). The non-dairy fermented water kefir base composition of the present disclosure comprises, consists essentially of, or consists of one or more of the following components: 1) a mash, 2) a starter culture, 3), a medium, and/or 4) an acid.

The non-dairy fermented water kefir base composition comprises, consists essentially of, or consists of about 1% to about 50% of the mash (see Table 1 below). Often, the base composition comprises, consists essentially of, or consists of about 1% to about 40%, about 1% to about 30%, about 1% to about 20%, about 1% to about 10%, about 1% to about 9%, about 1% to about 8%, about 1% to about 7%, about 2% to about 9%, about 3% to about 8%, about 4% to about 7%, about 5% to about 7.5% of the mash. In an illustrative embodiment, the base composition comprises about 6% to about 7%, about 6.5% to about 7%, about 6.6% to about 6.7%, about 6.65% to about 6.69%, and about 6.66% of the mash.

The mash of the base composition may comprise, consist essentially of, or consist of one or more of the following components: 1) water, 2) a sugar source, 3) a mineral blend, and 4) one or more enhancers. More specifically, the mash of the base composition may comprise, consist essentially of, or consist of: 1) about 30% to about 90% of water, 2) about 10% to about 50% of a sugar source, 3) about 0.01% to about 10% of a mineral blend, and 4) about 0.1% to about 10% of one or more enhancers (see Table 1 below). In an illustrative embodiment of the mash comprises, consists essentially of, or consists of: 1) about 40% to about 80% of water, 2) about 20% to about 40% of a sugar source, 3) about 0.01% to about 5% of a mineral blend, and 4) about 0.1% to about 5% of one or more enhancers.

The mash of the base composition comprises, consists essentially of, or consists of water from about any source providing potable water for human ingestion. The mash may comprise, consist essentially of, or consist of about 30% to about 90%, from about 40% to about 80%, from about 50% to about 70%, from about 65% to about 75%, from about 65% to about 70%, and about 65%, about 66%, about 67%, about 68%, about 69%, and about 70% of water. The base composition of the present disclosure may comprise, consist essentially of, or consist of about 1 to about 45%, from about 1% to about 40%, from about 1% to about 35%, from about 1% to about 30%, from 1% to about 25%, from 1% to about 20%, from 1% to about 15%, from 1% to about 10%, from 1% to about 5%, from 2% to about 5%, from 3% to about 5%, from 4% to about 5%, and about 5%, about 4.9%, about 4.8%, about 4.7%, about 4.6%, about 4.4%, about 4.3%, about 4.2%, about 4.1%, and about 4% of water (see Table 1 below). Illustrative water of the mash of the base composition includes, but is not limited to tap water, purified water, spring water, and/or distilled water. An illustrative embodiment of purified water of the present disclosure is reverse osmosis (RO) purified water.

The mash also comprises, consists essentially of, or consists of a sugar source. The mash may comprise, consist essentially of, or consist of about 10% to about 50%, from about 20% to about 40%, from about 25% to about 35%, from about 27% to about 33%, and from about 28% to about 32%, about 27%, about 27.5%, about 28%, about 28.5%, and about 29% of the sugar source. The base composition of the present disclosure may comprise, consist essentially of, or consist of about 1 to about 25%, from about 1% to about 20%, from about 1% to about 15%, from about 1% to about 10%, from 1% to about 5%, from 1% to about 4%, from 1% to about 3%, from 1% to about 2%, and about 2%, about 1.9%, about 1.8%, about 1.7%, about 1.6%, about 1.5%, about 1.4%, about 1.3%, about 1.2%, about 1.1%, and about 1% of sugar source (see Table 1 below). The sugar source of the mash comprises, consists essentially of, or consists of glucose, fructose, dextrose, sucrose, galactose, and/or any other simple or complex sugars used in production of food and beverage products. Illustrative embodiments of the mash sugar source include, but are not limited to cane sugar.

Cane sugar of the mash may be in different forms, including, but not limited to evaporated cane sugar, such as in a crystalline dextrose powder form (e.g., Dextrodyne). Another embodiment of the cane sugar source of the mash includes, but is not limited to granulated cane sugar. In another embodiment of the mash, granulated cane sugar replaces evaporated cane sugar as the sugar source, such that granulated cane sugar is the only sugar source for the mash.

This granulated cane sugar source embodiment of the mash comprises pure (100%) sucrose. The sucrose comprises a ratio of 45:55 fructose: glucose. The live yeast and/or live bacteria of the starter culture comprise an enzyme (e.g., invertase) that is able to cleave the fructose: glucose bonds. The free glucose is then metabolically converted to lactic acid by the live yeast and/or live bacteria of the starter culture. However, the majority of the cane sugar source remains as free fructose, which is not converted to lactic acid by the live yeast and/or live bacteria of the starter culture.

The mash may further comprise, consists essentially of, or consists of a source of nitrogen. The nitrogen source may be added to the mash to aid the water properties of the mash. An illustrative source of nitrogen for the mash of the present disclosure, includes, but is not limited to a nutritive yeast and/or yeast extract. The mash may comprise, consist essentially of, or consist of about 0.01% to about 10%, from about 0.01% to about 9%, from about 0.01% to about 8%, from about 0.01% to about 7%, from about 0.01% to about 6%, from about 0.01% to about 5%, from 0.01% to about 4%, from about 0.01% to about 3%, from about 0.01% to about 2%, and from about 0.01% to about 1%, from about 0.01% to about 0.09%, from about 0.01% to about 0.085%, from about 0.05% to about 0.09%, from about 0.065% to about 0.085%, about 0.08%, about 0.082%, about 0.083%, and about 0.084% of the nitrogen source.

The mash further comprises, consists essentially of, or consists of a mineral blend to aid the properties of the water of the mash. The mash may comprise, consist essentially of, or consist of about 0.01% to about 10%, from about 0.01% to about 9%, from about 0.01% to about 8%, from about 0.01% to about 7%, from about 0.01% to about 6%, from about 0.01% to about 5%, from 0.01% to about 4%, from about 0.01% to about 3%, from about 0.01% to about 2%, and from about 0.01% to about 1%, from about 0.01% to about 0.09%, from about 0.01% to about 0.085%, from about 0.05% to about 0.09%, from about 0.065% to about 0.085%, about 0.08%, about 0.082%, about 0.083%, and about 0.084% of the mineral blend. The base composition of the present disclosure may comprise, consist essentially of, or consist of about 0.001% to about 5%, from about 0.001% to about 4%, from about 0.001% to about 3%, from about 0.001% to about 1%, from 0.001% to about 0.5%, from 0.001% to about 0.25%, from 0.001% to about 0.1%, from 0.001% to about 0.05%, about 0.002%, about 0.003%, about 0.004%, about 0.005%, about 0.006%, about 0.007%, about 0.008%, about 0.009%, and about 0.01% of the mineral blend (see Table 1 below). The mineral blend typically comprises, consists essentially of, or consists of minerals including, but not limited to calcium chloride, magnesium chloride, manganese, and potassium bicarbonate. The mineral blend, the carbon source, or the nitrogen source may also comprise fructo-oligosaccharides or FOS.

Optionally, the non-dairy fermented water kefir base composition of the present disclosure may comprise additional components. More specifically, the mash of the base composition may also comprise, consist essentially of, or consist of one or more additional components, such as one or more enhancers (see Table 1 below). Enhancers of the mash or base composition comprise any composition, component, and/or action used to enhance the efficiency, precision, accuracy, productivity, characteristics, and/or features, including advantageous features or characteristics of the methods (e.g., fermentation) and/or compositions (e.g., the base or mash compositions) of the present disclosure.

More specifically, the mash may comprise, consist essentially of, or consist of about 0.1% to about 10%, from about 0.1% to about 9%, from about 0.1% to about 8%, from about 0.1% to about 7%, from about 0.1% to about 6%, from about 0.1% to about 5%, from about 0.1% to about 4%, from about 0.1% to about 3%, from about 0.1% to about 2%, and from about 0.1% to about 1%, from about 0.1% to about 0.9%, from about 0.1% to about 0.8%, from about 0.1% to about 0.7%, from about 0.1% to about 0.6%, about 0.1% to about 0.5%, about 0.1% to about 0.4%, about 0.1% to about 0.3%, about 0.1% to about 0.2% of the total of one or more enhancers. The base composition of the present disclosure may comprise, consist essentially of, or consist of about 0.01% to about 5%, from about 0.01% to about 4%, from about 0.01% to about 3%, from about 0.01% to about 2%, from about 0.01% to about 1%, from 0.01% to about 0.5%, from 0.01% to about 0.25%, from 0.01% to about 0.1%, from 0.01% to about 0.05%, about 0.02%, about 0.03%, about 0.04%, about 0.05%, about 0.06%, about 0.07%, about 0.08%, about 0.09%, and about 0.1% of the total of one or more enhancers (see Table 1 below).

Additional components that may be added to the mash and/or base composition as enhancers include, but are not limited to, botanicals, fruit ingredients, or extracts found to enhance fermentation. Illustrative additional enhancers of the mash or base composition of the present disclosure that enhance fermentation include, but are not limited to flavoring agents, surfactants, adjuvants, excipients, dispersants, emulsifiers, colorings, additives, probiotics, etc.

For example, the mash of the base composition may comprise, consist essentially of, or consist of one or more flavoring agents. The mash may comprise, consist essentially of, or consist of about 0.1% to about 4%, from about 0.1% to about 3%, from about 0.1% to about 2%, and from about 0.1% to about 1%, from about 0.1% to about 0.9%, from about 0.1% to about 0.85%, from about 0.1% to about 0.9%, from about 0.5% to about 0.9%, about 0.8%, about 0.85%, about 0.9%, and about 1% total of any one or more flavoring agents.

Flavoring agents of the present disclosure may comprise any natural and/or artificial compositions or components used in the food and/or beverage arts to add and/or enhance the flavor of a product safe for human ingestion. More specifically, illustrative flavoring agents of the mash of the present disclosure include, but are not limited to natural or artificial flavors of vegetables, fruits, berries, melons, citrus, herbs, astragalus, etc. For example, illustrative flavoring agents of the mash of the present disclosure include, but are not limited to natural flavorings of ginger, lemon, fig, apple, mojito, ginger, astragalus, and/or orange.

Another optional flavoring agent that may be added to the non-dairy fermented water kefir mash and/or base composition of the present disclosure is one or more natural fruits, herbs, and/or vegetables, including juices, pieces, portions, syrups, and/or extracts thereof. Fruits, herbs, and vegetables of the present disclosure may comprise any fruits, herbs, and/or vegetables that may be used in food and/or beverage products and that are safe for ingestion by subjects, such as humans. Generally, the amount of natural fruits, herbs, vegetables, and/or extracts thereof added to the mash and/or the base composition of the present disclosure ranges from about 0.01% to about 1%, and generally from about 0.01% to about 0.5%, from about 0.02% to about 0.48%, and often about 0.025% to about 0.5%.

Fruits, herbs, and vegetables include, but are not limited to whole fruits, herbs, and/or whole vegetables, as well as pieces or portions of whole fruits, herbs, and/or whole vegetables, including, but not limited to pulp, leaves, flowers, seeds, berries, stems, skin/rind, etc. Illustrative fruits of the present disclosure include, but are not limited to figs, dates, grapes, cherries, tomatoes, apples, berries (e.g., strawberries, raspberries, blueberries, acai berries, etc.), melons (e.g., watermelon, cantaloupe, honeydew melon, etc.), coconut, citrus (oranges, lemons, limes, pineapple, etc.), and others. An exemplary fruit of the present disclosure is one or more whole figs (e.g., a plurality of whole figs). Illustrative vegetables of the present disclosure include, but are not limited to kale, spinach, broccoli, peppers, etc. Illustrative herbs of the present disclosure include, but are not limited to acai, cayenne, ginger, turmeric, basil, oregano, astragalus, etc.

Natural fruit and/or vegetable extracts that may specifically be used as flavoring agents of the present disclosure comprise compositions extracted from whole, pieces, and/or portions of fruits and/or vegetables, such as fruit juice or fruit pulp, or any other downstream products made from fruit and/or vegetables extracts. For example, fruit syrup, often made from juice extracted from whole or portions of fruits and/or vegetables, is an illustrative example of an optional enhancer component of the mash and/or base composition of the present disclosure. An exemplary fruit syrup of the present disclosure is fig syrup.

An additional enhancer that may be added to the mash of the base composition of the present disclosure is a salt. Any salt used in food and/or beverage processes may be added to the mash of the present disclosure. In one embodiment, the mash of the present disclosure does not comprise a salt.

Another enhancer that may be comprised in the mash and/or base composition of the present disclosure may comprise, consist essentially of, or consist of a yeast extract. Yeast extract is not and does not comprise live yeast. Instead, yeast extract is often a lysate of cells from yeast strains, including, but not limited to Saccharomyces (e.g., Saccharomyces cerevisiae). Typically, the cells of the yeast extract are dried (e.g., spray-drying) so as to produce a powder. While any form of yeast extract may be used (i.e., tablet, powder, liquid, etc.) as a fermentation enhancer of the present disclosure, a powdered yeast extract is an illustrative embodiment of the yeast extract component.

Yeast extracts add nutrients and vitamins necessary to promote and/or improve microbial growth, particularly B-complex vitamins, which are almost completely conserved in yeast extract. Therefore, yeast extract may optionally be added to the mash and/or base composition of the present disclosure as a protein and/or amino acid source to feed the live yeast and/or live bacteria in the starter culture. In particular, the yeast extract serves as a source of food, nutrition, and/or energy for live bacteria.

Generally, the amount of yeast extract added to the base composition of the present disclosure ranges from about 0.1% to about 10%, and generally from about 0.1% to about 5%, from about 0.5% to about 2.5%, from about 0.5% to about 1.5%, and from about 1% to about 1.5%. Biolyfe™ 537a and Fermentation Nutrient Ingredient-100 (FN-100) are commercially available embodiments of yeast extract that may be added as an enhancer component of the described base composition. The yeast extract enhancer may also add some salty flavor profiles to the base composition, such that it may also act as a flavoring agent of the mash of the present disclosure. Similarly, some flavoring agents (e.g., whole figs and/or fig syrup) may also serve as a sugar source and/or a coloring enhancer for the base composition.

If optional enhancer components are added to the mash and/or base composition of the present disclosure, the total concentration of the optional enhancer components comprise no more than about 5% of the mash composition of the total non-dairy fermented water kefir base composition. More specifically, the total amount of additional components may comprise from about 5% or less, from about 3% to about 4%, from about 3.5% to about 4%, such as about 3.85% of the mash composition. In addition, such enhancer components comprise from about 1.5% or less, from about 0.5% to about 1.5%, from about 1% to about 1.5%, and about 1.05% of the total base composition.

In addition, the base composition of the present disclosure comprises about 0% to about 0.05% of the starter culture, and typically from about 0.005% to about 0.03%, from about 0.005% to about 0.04%, from about 0.0075% to about 0.02%, from about 0.005% to about 0.015%, and from about 0.001% to about 0.015%, and from about 0.001% to about 0.011% of water kefir culture. A starter culture of the non-dairy fermented water kefir base composition may comprise, consist essentially of, or consist of little to no water kefir grains. For example, an illustrative starter culture of the present disclosure may comprise, consist essentially of, or consist of no (i.e., at or about 0%) water kefir grains. In other words, in an exemplary embodiment of the present disclosure, no water kefir grains are required to establish a stable water kefir culture.

The water kefir culture of the present disclosure comprises, consists essentially of, or consists of live yeast only, live bacteria only, or a combination thereof. For example, the water kefir culture of the present disclosure comprise, consist essentially of, or consist of a combination of live yeast and live bacteria. An exemplary embodiment of the water kefir culture of the present disclosure comprise, consist essentially of, or consist of live yeast and/or live bacteria that are a symbiotic colony of bacteria and yeast (SCOBY).

Generally, it is understood in the art that live yeast metabolize sugar to produce alcohols, such as ethanol. However, live bacteria do not generally have the same ability as live yeast to metabolize sugar to produce ethanol. Instead, live bacteria typically metabolize sugar to produce lactic acid.

Each strain of live yeast and/or live bacteria comprised by the SCOBY may not be able to metabolize sugar to lactic acid since some may only be able to metabolize sugar to ethanol. However, collectively, the different strains of live yeast and/or live bacteria (e.g., SCOBY) of the starter culture must be able to convert sugar in order to produce lactic acid.

Since live yeast are known to metabolize sugar to ethanol, the live yeast and/or live bacteria of the present disclosure, including the SCOBY, does not require live yeast. Therefore, one embodiment of the base composition of the present disclosure comprises water kefir grains that do not comprise, consist essentially of, or consist of live yeast at all. Such embodiments of the base composition comprise a starter culture that comprises, consists essentially of, or consists of live bacteria only. In another embodiment, the base composition comprises a starter culture that comprises, consists essentially of, or consists of live bacteria and yeast components that are not living, such as yeast extracts, nutrients, peptides, amino acids, nucleic acids, and other compositions derived from yeast that are no longer living.

The water kefir grains of live yeast and/or live bacteria may comprise any amount or concentration of active units of live yeast and/or live bacteria that is able to establish and grow a healthy colony or culture of live yeast and/or live bacteria. The usage rate of water kefir grains is about 1 kg of grains containing active cultures of yeast and bacteria for every 350-400 Liters of nutrient base. Typically, the total active units of live yeast and/or live bacteria in the water kefir grains of the starter culture is produced by active units of one or more different strains of live yeast, live bacteria, and/or combinations thereof. The water kefir grains of the starter culture may comprise 1 to 50 different strains of live yeast and/or live bacteria. For example, the starter culture of the present disclosure may comprise 1 to 40, 1 to 30, 1 to 20, 1 to 10, 1 to 9, 1 to 8, 1 to 7, 1 to 6, 1 to 5, 1 to 4, 1 to 3, 1 to 2, 2 to 10, 2 to 9, 2 to 8, 2 to 7, 2 to 6, 2, to 5, 2 to 4, 2 to 3, 3 to 10, 3, to 9, 3 to 8, 3 to 7, 3 to 6, 3 to 5, 3 to 4, 4 to 10, 4 to 9, 4 to 8, 4 to 7, 4 to 6, 4 to 5, 5 to 10, 5 to 9, 5 to 8, 5 to 7, 5 to 6, 6 to 10, 6 to 9, 6 to 8, 6 to 7, 7 to 10, 7 to 9, 7 to 8, 8 to 10, 8 to 9, 9 to 10, and at or about five (5) different strains of live yeast and/or live bacteria. In one embodiment, the live bacterial strains of the starter culture comprise, consist essentially of, or consist of the following five (5) strains: Streptococcus thermophiles, Lactobacillus delbrueckii subsp. Bulgaricus, Lactobcillus acidophilus, Lactobacillus paracasei subsp., and Bifidobacterium animalis. In another embodiment, the starter culture comprises the same five (5) bacterial strains (i.e., Streptococcus thermophiles, Lactobacillus delbrueckii subsp. Bulgaricus, Lactobcillus acidophilus, Lactobacillus paracasei subsp., and Bifidobacterium animalis) with no live yeast present in the starter culture.

A medium of the present disclosure provides the necessary nutrient-rich environment where the live yeast and/or live bacteria of the starter culture is processed and/or grown in order to produce a larger culture comprising, consisting essentially of, or consisting of a base composition, such as the non-dairy fermented water kefir base composition of the present disclosure. Often, a culture or “starter culture” of water kefir grains comprising live yeast and/or live bacteria (e.g., SCOBY) may be grown or purchased in the presence of an allergen-free base or medium, such as a dairy allergen-free base or medium. To produce a base composition, the starter culture may be inoculated onto a medium, including, but not limited to a solid medium, a liquid medium, a gel medium, and other types of mediums known in the art for use in microbial cell culture.

An illustrative solid medium of the present disclosure is a piece of fruit. An exemplary medium for the non-dairy fermented water kefir base composition of the present disclosure is a liquid medium. A liquid medium within which the water kefir grains of the starter culture are inoculated may comprise, consist essentially of, or consist of a solution and a sugar. In some embodiments, the liquid medium comprises a solution, but does not comprise a sugar.

An illustrative solution of the liquid medium of the present disclosure is an aqueous solution. An aqueous solution of the medium may comprise, consist essentially of, or consists of water, juice, and/or syrup (e.g., fruit and/or vegetable juice or syrup). An exemplary medium of the present disclosure is purified water, such as RO water.

Typically, the liquid medium of the base composition comprises, consists essentially of, or consists of about 70% to about 99% of the base composition of the present disclosure. More specifically, base composition embodiments of the present disclosure may comprise, consist essentially of, or consist of about 75% to about 97%, from about 80% to about 95%, from about 85% to about 95%, from about 87% to about 94%, from about 88.4% to about 93.5% of water, such as RO water. Notably, a base composition embodiment comprising apple cider vinegar (ACV) will also comprise a lower amount of water (i.e., ranging from about 85% to about 95%) than base composition embodiments that do not comprise ACV, which have a concentration of water ranging from about 90% to about 99%.

A sugar of the liquid medium may comprise glucose, fructose, sucrose, and/or any other simple or complex sugars used in production of food and beverage products. The sugar of the liquid medium may also be a combination of any simple and/or complex sugars or carbohydrates.

Typically, the non-dairy fermented water kefir base composition of the present disclosure may have a sugar concentration of about 200 Brix (°Bx) to about 1°Bx. However, such high sugar content may be diluted to provide a final working concentration of sugar in the composition that ranges from about 50 Brix (°Bx) to about 1°Bx. More specifically, the concentration of sugar in the base composition of the present disclosure may comprise a range of about 40 to 1oBx, 30 to 1oBx, 25 to 1oBx, 20 to 1°Bx, 15 to 1°Bx, 10 to 1°Bx, and 5 to 1°Bx, 50 to 2°Bx, 40 to 2°Bx, 30 to 2°Bx, 25 to 2°Bx, 20 to 2°Bx, 25 to 2°Bx, 20 to 2°Bx, 5 to 2°Bx, and 2.25 to 2°Bx.

In addition to the mash, the starter culture, and the medium, the non-dairy fermented water kefir base composition of the present disclosure may also comprise, consist essentially of, or consist of an acid. An acid of the present disclosure may be any acid appropriately used in the preparation of food and beverage products safe for ingestion by subjects, such as humans. In addition, food and/or beverage safe acids must also be able to significantly reduce or lower the pH of a composition, such as a mixture of starter culture and medium, the mash composition, and/or the final non-dairy fermented water kefir base composition. For example, an acid of the present disclosure includes, but is not limited to acetic acid, lactic acid, citric acid, fumaric acid, phosphoric acid, malic acid, oxalic acid, ascorbic acid, and combinations thereof.

An exemplary acid of the present disclosure may have an alkalizing effect. Illustrative acid components of the base composition include lactic acid and acetic acid. However, in one embodiment, the acid is not lactic acid. An exemplary acid component of the non-dairy fermented water kefir base composition is acetic acid. Preferably, acetic acid is provided as a component of the non-dairy fermented water kefir base composition in the form of apple cider vinegar (ACV).

Apple cider vinegar comprised within the non-dairy fermented water kefir base composition of the present disclosure may be pure or diluted. While any concentration of ACV able to reduce the pH of a composition is sufficient for the base composition of the present disclosure, typically, a range of about 30% to about 100% (i.e., pure) ACV may be added as a component of the non-dairy fermented water kefir base composition. For example, apple cider vinegar that is 30%, 35%, 40%, 45%, 50%, 55%, 60%, 65%, 70%, 75%, 80%, 85%, 90%, 95%, 96%, 97%, 98%, 99%, or 100% pure may be used as a component of the base composition.

The final concentration of ACV may range from about 0.1% to about 30% in the non-dairy fermented water kefir base composition (see Table 1 below). More specifically, ACV in the base composition may range from about 0.1% to about 20%, about 0.1% to about 10%, 0.1% to about 9%, about 0.1% to about 8%, about 0.1% to about 7%, about 0.1% to about 6%, about 0.5% to about 10%, about 0.5% to about 9%, about 0.5% to about 8%, about 0.5% to about 7%, about 0.5% to about 6%, about 1% to about 10%, about 1% to about 9%, about 1% to about 8%, about 1% to about 7%, about 1% to about 6%, about 1% to about 5.5%, about 1% to about 5.4%, about 1% to about 5.3%, about 2% to about 10%, about 2% to about 9%, about 3% to about 8%, about 4% to about 7%, about 5% to about 6%, about 5% to about 5.5%, about 5% to about 5.2%, about 5.1% to about 5.2%, 6% or less, and less than 6%. The non-dairy fermented water kefir base composition of the present disclosure is produced by the combination of the mash, the starter culture, the medium, the acid (e.g., apple cider vinegar), and any optional/additional enhancer components. Once combined, the base composition may be included in food and/or beverage products for ingestion by subjects, such as humans. Illustrative food and/or beverage products comprising the non-dairy fermented water kefir base composition may be in various forms, including, but not limited to food, snacks, elixirs, shots, shooters, spoonables, smoothies, shakes, soups, and beverages.

Illustrative beverages comprising the non-dairy fermented water kefir base composition of the present disclosure include, but are not limited to nutritional beverages, such as beverages that affect and/or improve gut and/or gastrointestinal health of a subject (e.g., a human). More specifically, beverage products comprising the base composition include, but are not limited to teas, kombuchas, lattes, coffees, frappes, apple cider vinegar tonics (ACVTs), and sparkling probiotic drinks (SPDs), such as Kevita® brand products. Illustrative beverages that are commercially available may comprise SPDs having the following flavor profiles of lemon cayenne, strawberry acai, coconut lime mojito, lemon ginger, and turmeric ginger. Illustrative beverages that are commercially available may comprise ACVTs having a flavor profile, such as turmeric ginger, lemon, elderberry, or ginseng mandarin.

In addition, the non-dairy fermented water kefir base composition of the present disclosure may comprise from about 1% to about 25% of a food and/or beverage product, particularly a food and/or beverage product for commercial and/or retail sale. More specifically, the base composition of the present disclosure may comprise about 1% to about 25%, from about 2% to about 20%, from about 5% to about 20%, from about 2% to about 17%, from about 5% to about 17%, from about 4% to about 18%, and from about 3% to about 19% of a food and/or beverage product of the present disclosure.

Additionally, the food and/or beverage products comprising the base composition of the present disclosure include, but are not limited to food and/or beverage products that labeled and/or designated as GRAS, food grade, allergen free, certified organic or “organic,” kosher, vegan, and, non-GMO. In an illustrative embodiment, the food and/or beverage products comprising the non-dairy fermented water kefir base composition may be marketed and labelled as “organic.” The “organic” food and/or beverage product comprising the non-dairy fermented water kefir base composition of the present disclosure does not sacrifice any health benefits of its “organic” acid profile versus inorganic acids, which do not contain carbon. In addition, the organic food and/or beverage products of the present disclosure provide similar sensory qualities as products produced via prior art methods of fermentation.

TABLE 1

| | | | ii. | | | |
|---|---|---|---|---|---|---|
| | | i. | % MASH | iii. | iv. | v. |
| | | % Ranges in | added to | % Ranges in | % in BASE | % in BASE |
| | Ingredients | MASH | BASE | BASE | without ACV | with ACV |
| MASH | Yeast Extract (Enhancer) | 0.1-10% | 6.660% | 0.001-1% | 0.100% | 0.095% |
| | Mineral Blend | 0.01-10% | | 0.001-5% | 0.006% | 0.005% |
| | Herb Extract (Enhancer) | 0.1-10% | | 0.01-2% | 0.030% | 0.028% |
| | Fruit Syrup (Enhancer) | 0.1-10% | | 0.01-2% | 0.028% | 0.026% |
| | Cane Sugar | 10-50% | | 1-25% | 1.900% | 1.796% |
| | Water | 30-90% | | 1-45% | 4.604% | 4.351% |
| | Starter Culture | | 0.011% | 0.005-1% | 0.011% | 0.010% |
| | Medium added to form BASE | | 93.320% | 70-99% | 93.32% | 88.537% |
| | Apple Cider Vinegar | | | 0.1-30% | | 5.198% |
| | TOTAL | | 100.0% | | 100.0% | 100.0% |

### Methods of the Present Disclosure

The present disclosure is also directed to methods of making and/or using the non-dairy fermented water kefir base composition described above. More specifically, the present disclosure is directed to a method or process of making the non-dairy fermented water kefir base composition of the present disclosure and/or a process of using the non-dairy fermented water kefir base composition of the present disclosure. In particular, the method of making the non-dairy fermented water kefir base composition of the present disclosure comprises, consists essentially of, or consists of the process of fermentation. In addition, the present disclosure is directed to a method of fermenting the non-dairy water kefir base composition.

Generally, “fermentation” or the process of “fermenting” refers to the metabolic process where carbohydrates, such as sugars, are metabolized by enzymes within “live yeasts” and/or “live bacteria” of the water kefir grains in the starter culture and converted into acids (e.g., lactic acid), gases (e.g., carbon dioxide), alcohols (e.g., ethanol), and/or energy (e.g., ATP). In particular, fermentation of sugar in the current method of making the base composition includes adding the mash and the medium (e.g., water) to the starter culture comprising “live yeasts” and/or ‘live bacteria” in order to form a mixture.

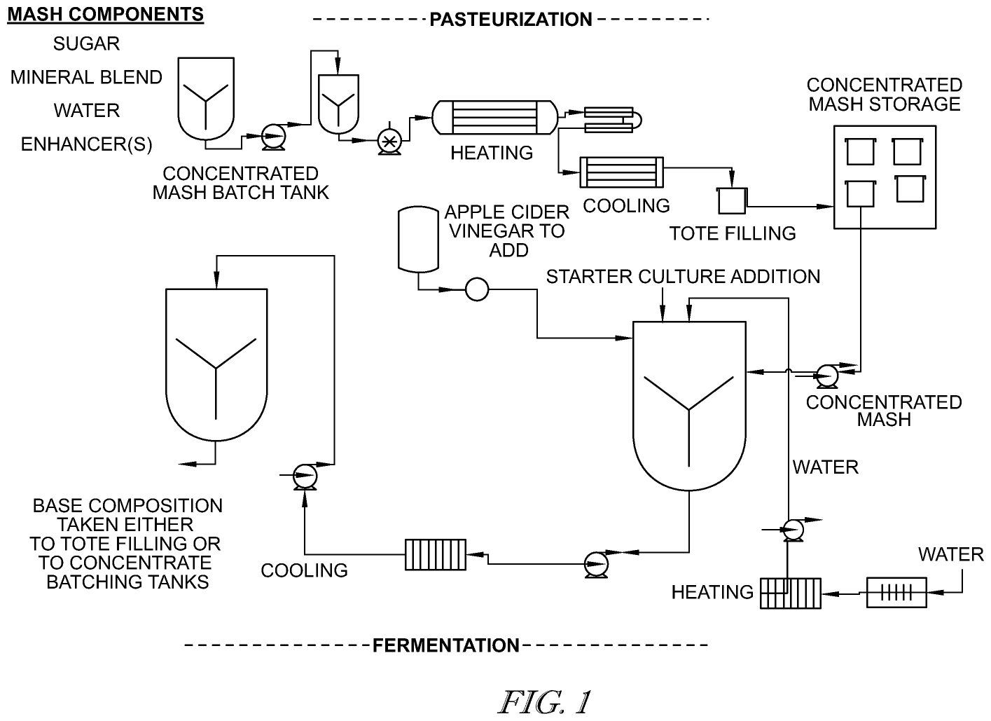

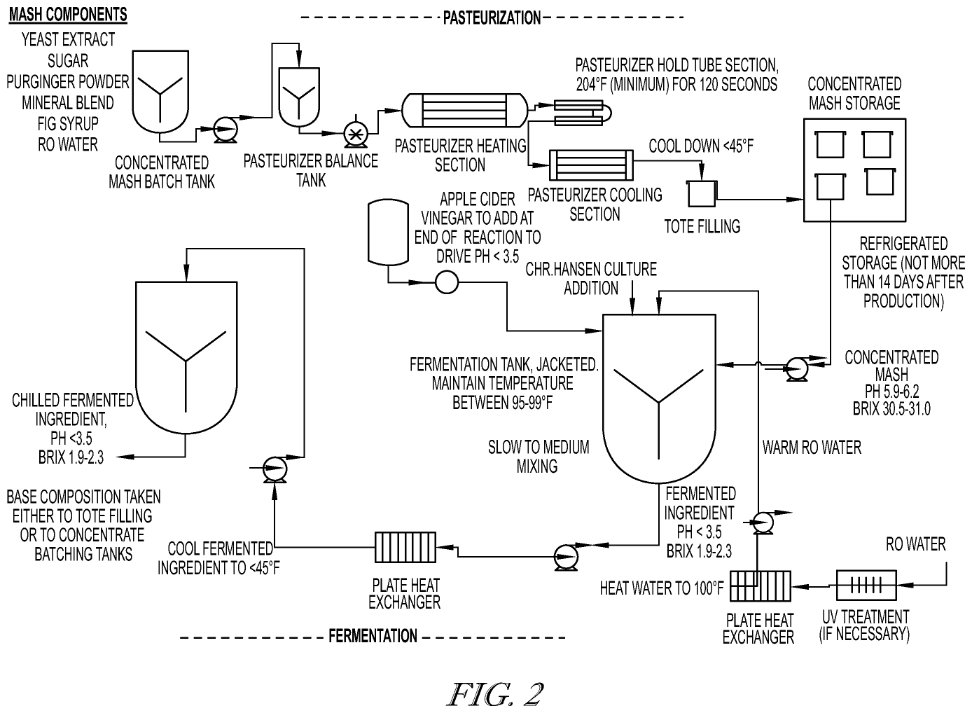

The components of the mash, including, but not limited to water, the sugar source, the mineral blend, and the one or more enhancers (e.g., herb extract, fruit syrup, and yeast extract) may be mixed and concentrated (see FIGS. 1 and 2). In some embodiments of the present methods of making, producing, and/or fermenting the base composition, the methods may optionally comprise, consist essentially of, or consist of one or more sterilization processes to eliminate harmful microbes. Illustrative sterilizing or sanitizing processes of the present methods include, but are not limited to pasteurization and/or irradiation.

An illustrative embodiment of an irradiation method comprises ultraviolet (UV) light treatment. While UV light treatment may be performed at any wavelength sufficient to eliminate (e.g., kill) microbes from the mash and/or base compositions, the preferred process to eliminate pathogenic microorganisms from the mash and/or base composition of the present disclosure is pasteurization. For example, once mixed and concentrated, the mash composition may then be further irradiated and/or pasteurized in order to kill and/or eliminate any harmful microorganisms and therefore, sterilize the mash and/or base composition and the downstream food and/or beverage product. In an exemplary method, the mash and/or base composition is pasteurized.

Often, the pasteurization process occurs in a tank comprising a hold tube where the mash composition may be held for about 30 seconds prior to heat processing. The pasteurization process is typically conducted at a minimum heat temperature of about 93° C. (i.e., about 199° F.). For example, the mash may be heat pasteurized to kill any pathogenic microbes at a temperature ranging from about 93° C. to about 135° C., from about 93° C. to about 125° C., from about 93° C. to about 115° C., from about 93° C. to about 105° C., from about 93° C. to about 100° C., from about 93° C. to about 99° C., from about 93° C. to about 98° C., from about 93° C. to about 97° C., from about 93° C. to about 96° C., from about 93° C. to about 95° C., from about 93.4° C. to about 94.4° C., and finally at or about 94.4° C.

The mash mixture may be heat pasteurized for any amount of time sufficient to eliminate microbial pathogens. Typically, the time period for pasteurization of the mash composition ranges from about 120 to about 480 seconds, from about 120 to about 240 seconds, and often at about 120 seconds (see FIGS. 1 and 2). In some embodiments, a minimum of at least about 120 seconds of heat exposure is required for sufficient pasteurization of the mash and/or base composition of the present disclosure.

After heat pasteurization, the mash mixture may be cooled down to a temperature at or below about 7° C. (i.e., 45° F. or below). The cooled pasteurized mash may be filled in a tote as a concentrated mash in preparation for storage (see FIGS. 1 and 2). Alternatively, the mash may be stored directly without tote filling. In one embodiment, the mash composition is pasteurized prior to storage (e.g., refrigerated storage) in order to prevent and/or reduce microbial growth upon or within the mash and/or base composition during the storage period.

Storage of the concentrated mash mixture is usually for 14 days and not more unless it is produced and filled aseptically which could increase storage life further, after production of the mash mixture. Storage of the mash may occur for a time period ranging from about 1 day to about 365 days (i.e., 1 year or more), and often ranges from about 7 days to about 90 days, from about for about 10 days to about 60 days, from about 14 days (e.g., about 2 weeks) to about 30 days, and typically around about 14 days or 2 weeks. More specifically, refrigerated storage of the mash mixture may occur at a temperature ranging from about 4oC to about 6oC for up to about 1 year. During that storage time period, the concentrated mash may have a pH ranging from about 5.5 to about 6.5, and more closer to about 5.9 to about 6.2. In addition, the Brix of the concentrated mash mixture during this storage period may range from about 31°Bx to about 30°Bx, and at or about 31°Bx to about 30.5°Bx.

The concentrated mash is then moved to a different or separate tank or container having a temperature ranging from about 35° C. to about 37.5° C. (see FIGS. 1 and 2). The starter culture and medium are added to the mash in order to begin the fermentation process via slow to medium mixing. In an illustrative embodiment, the medium of the mixture is liquid. In one embodiment, the medium of the mixture is water. In another embodiment, the water is RO water. Further, the water may be warm or hot water having a temperature ranging from about 35° C. to about 37.5° C. In some embodiments, the water comprises sugar.

In one embodiment, the water kefir grains of the starter culture may be inoculated onto or into a liquid medium (e.g., water) at any concentration that supports the establishment and growth of a stable colony or culture of live yeast and/or live bacteria and/or fermentation by the live yeast and/or live bacteria. Preferably, the water kefir grains comprising the live yeast and/or live bacteria are inoculated into the liquid medium at a concentration of about 1 kg for about every 350 to about 400 kg of liquid medium. The mixture of the mash, starter culture, and water medium results in a pH at, about, or below 3.5, and a Brix that may range from about 1.5°Bx to about 2.5°Bx, and at or about 1.9°Bx to about 2.5°Bx, such as about 2.0°Bx to about 2.4°Bx.

In another embodiment, frozen pellets of the starter culture may be inoculated onto or into a liquid medium (e.g., water) at any concentration that supports the establishment and growth of a stable colony or culture of live yeast and/or live bacteria and/or fermentation by the live yeast and/or live bacteria. Preferably, the frozen pellets comprising the live yeast and/or live bacteria are inoculated into the liquid medium at a concentration ranging from about 0.01% to about 0.05% of starter culture (at a strength/concentration of about 1×10⁵ to about 1×10⁸ CFU/g) per liter of medium. This equates to 500 g of starter culture (at a strength/concentration of about 1×10⁵ to about 1×10⁸ CFU/g) for 5000 L of medium or 1 gram of starter culture (at a strength/concentration of about 1×10⁵ to about 1×10⁸ CFU/g) for 5000 L of medium or 1 gram of starter culture (at a strength/concentration of about 1×10⁵ to about 1×10⁸ CFU/g) for 10 L of medium. The mixture of the mash, starter culture, and water medium results in a pH at, about or below 3.5 and a Brix that may range from about 1.5°Bx to about 2.5°Bx, and at or about 1.9°Bx to about 2.5°Bx, such as about 2.0°Bx to about 2.4°Bx.

Once the mash and/or medium are inoculated with the live yeast and/or live bacteria of the starter culture, the mixture is placed in an atmosphere to promote metabolism and fermentation. Typically, the fermentation process of the present disclosure occurs at anaerobic conditions to promote the production of lactic acid, or lactate, which is lactic acid in solution. The presence of oxygen in any significant amount (e.g., at or about 20-21% or more) often kills the live yeast and/or live bacteria used for fermenting the mixture of the present disclosure. Thus, the method of making, producing, and/or fermenting the base composition of the present disclosure is typically conducted or occurs in one or more containers or tanks to promote an anaerobic environment.

Any container used in the food and/or beverage industry, particularly the commercial food and/or beverage industry, will suffice to promote the anaerobic environment used in the present process of fermentation. Illustrative containers to conduct the present methods include, but are not limited to containers made of glass, metal, plastic, polypropylene, polystyrene, etc. Exemplary embodiments of the form or shape of containers that may be used for the present methods include, but are not limited to bottles, beakers, cups, jars, dishes (e.g., petri dish), bowls, etc.

An illustrative container of the present disclosure is a tank. The tank of the present disclosure may be sealable or unsealable, as well as sealed or unsealed. The tank of the present disclosure may also be permeable or impermeable to gases, such as air or other gases. In one embodiment, the tank of the present disclosure is sealable, sealed, and air-tight, such that it is impermeable to gases and/or air. In an illustrative embodiment, the tank of the present disclosure is an air-tight and/or sealable tank often used in manufacturing.

Such a tank may have any shape or form that provides the anaerobic environment necessary to promote fermentation and/or production of large batches of the mash and/or base composition. Any such tank, also called batch tanks, known and/or used for the safe manufacturing of food and/or beverages may be used as a tank of the present disclosure. For example, the making, mixing concentrating, heating, cooling, pasteurizing, sterilizing, fermenting and/or producing of the mash and/or base composition of the present disclosure may be performed in a tank or batch tank for commercial and/or industrial use. Often, batch tanks may comprise a volume ranging from about 100 liters to about 40,000 liters of mash and/or base composition.

Known as the homolactic fermentation pathway or the homofermentative process, this method of fermentation generally converts one molecule of a sugar (e.g., glucose, sucrose, dextrose, and fructose) to two molecules of lactic acid. Alternatively, carbon dioxide, hydrogen gas, acetic acid, and/or ethanol may also be produced, in addition to lactic acid, using a phosphoketolase or pentose phosphate pathway of heterolactic fermentation or the heterofermentative process. In both homofermentative and/or heterofermentative methods, in addition to live yeast, live bacteria that may be incorporated into the mixture include, but are not limited to bacteria from genuses Lactobacillus, Streptococcus, Pediococcus, Lactococcus, Leuconostoc, Aerococcus, Carnobacterium, Enterococcus, Oenococcus, Sporolactobacillus, Tetragenococcus, Vagococcus, and/or Weissella. However, in both methods of homofermentation and heterofermentation, lactic acid is a primary product of the fermentation pathway.

Illustrative fermentation conditions include placement of the mixture at a temperature ranging from about 20° C. to about 50° C., from about 30° C. to about 50° C., from about 35° C. to about 50° C., from about 25° C. to about 50° C., from about 36° C. to about 50° C., from about 25° C. to about 45° C., from about 25° C. to about 40° C., from about 25° C. to about 35° C., from about 25° C. to about 30° C., from about 30° C. to about 45° C., from about 30° C. to about 40° C., from about 30° C. to about 35° C., from about 20° C. to about 45° C., from about 20° C. to about 40° C., from about 20° C. to about 35° C., from about 20° C. to about 30° C., and from about 30° C. to about 40° C., such as about 32° C. to about 38° C., and about 34° C. to about 38° C.

Generally, the mixture will be allowed to ferment at the temperatures described herein for about 12 to 48 hours in order for the fermentation process to fully complete. However, the claimed methods comprise fermentation processing times that are advantageously faster than 48 hours or more. Often times, the fermentation process is completed within about 12 to about 24 hours, from about 12 to about 20 hours, from about 14 to about 22 hours, from about 16 to about 20 hours, from about 16 to about 18 hours, at about 16 hour, at about 16 hours or less, at less than 16 hours, at less than 24 hours, at less than 18 hours, at less than 20 hours, at less than 14 hours, and at less than 12 hours. As described below, the present methods also comprise fermentation times that are even shorter than currently described.

Growth and proliferation of the live yeast and live bacteria also aid the metabolism and/or fermentation of the sugar by the live yeast and/or live bacteria to produce lactic acid. Growth conditions for culturing the live yeast and live bacteria correspond with any conditions known in the art for proper fermentation of sugar by the live yeast and live bacteria in order to produce lactic acid.

More specifically, in one embodiment, the process of making and/or fermenting the non-dairy water kefir base composition of the present disclosure comprises adding live yeast and/or live bacteria into a mash and a liquid medium to provide a mixture. The live yeast and/or live bacteria metabolize the sugar in the liquid medium via the process of fermentation. The method of making or fermenting the base composition of the present disclosure results in the formation and/or production of acids comprising, consisting essentially of, or consisting of lactic acid.

Rapid formation of lactic acid by the mixture of live yeast and/or live bacteria via fermentation of the sugar in the medium also lowers the pH of the mixture, which generally ranges from about pH 5.5 to about pH 6.5, and often at or about pH 5.8, pH 5.9, pH 6.0, pH 6.1, and/or pH 6.2. As the fermentation process slows and/or comes to a stop, sufficient lactic acid will be produced via the fermentation process. For example, lactic acid in the range of about 0.1% to about 0.5% is generally produced by the described methods. More specifically, the present methods produce about 0.2% to about 0.4% of lactic acid, and often about 0.3%. To slow and/or stop the fermentation process, the reaction is cooled, such as by cooling the tank. Typically, the fermentation process slows or is stopped when the temperature falls below about 10° C., such as below about 7° C.,

In addition, a component may be added to the fermentation reaction to lower the pH of the mixture. A component may also be added to the fermentation reaction to increase the titratable acidity (TA). To elaborate, the titratable acidity of a fermentation reaction is a measure of the total amount of hydrogen ions present. The addition of ACV increases the complexity of organic acids present that have buffering capacity important to maintain a low pH and thus contribute to longer shelf life. Many pathogens do not grow in environments with a low pH and a higher TA. Further, the titratable acidity typical of the lactic acid fermentation reaction described in the present disclosure ranges from about 0.2 to about 0.4 after the addition of a component of the present disclosure.

A component of the base composition that may be added to the fermentation reaction mixture in order to lower the pH and/or increase the titratable acidity (TA), includes, but is not limited to an acid that is not lactic acid. For example, an acid of the present disclosure may be an alkylating acid. More specifically, acetic acid may be added to the mixture of live yeast and live bacteria, a mash, and a liquid medium. In one preferred embodiment, acetic acid may be added to the mixture in the form of apple cider vinegar (ACV).

Addition of apple cider vinegar (ACV) to the mixture of the present disclosure produces the non-dairy fermented water kefir base composition of the present disclosure. More specifically, after stopping the fermentation reaction by lowering the temperature to about 7° C., apple cider vinegar (ACV) may be added to the mixture. Addition of ACV to the mixture lowers the pH of the mixture to a target pH and/or increased the TA (as described above). In an additional illustrative embodiment, the ACV may be pasteurized prior to addition to the mixture in order to ensure that addition of the ACV to the mixture does not introduce microbial contamination to the base composition or final product.

Importantly, ACV should be added to the mixture at the appropriate time or stage of the fermentation reaction. Notably, the ACV should be added to the mixture of live yeast and/or live bacteria and the medium after the fermentation process has advanced a substantial degree. More specifically, ACV should be added to the mixture when the fermentation process has slowed and/or stopped to a point that the pH ranges from about pH 3.3 to about pH 4.7. In particular, the ACV may be added to the mixture of live yeast and/or live bacteria and the medium when the pH of the mixture is from about pH 3.4 to about pH 4.6, from about pH 3.5 to about pH 4.5, from about pH 3.2 to pH 4.2, from about pH 3.6 to about pH 4.3, from about pH 3.8 to about pH 4.6, and from about pH 3.8 to about pH 4.2. In one embodiment, the ACV may be added when the pH is at about pH 4.6, pH 4.5, pH 4.4, pH 4.3, pH 4.2, pH 4.1, pH 4.0, pH 3.9, pH 3.8, pH 3.7, pH, 3.6, pH 3.5, pH 3.4, and/or pH 3.3. If the ACV is not added to the mixture at the appropriate time (as described herein), an advantageously shortened overall processing time for production of the base composition (as described in detail below) will not be realized.

Slowing and/or stopping the fermentation process also stops the production of lactic acid. Importantly, addition of ACV to the mixture lowers the pH of the mixture to a target pH. The target pH of the present fermentation reaction ranges from about pH 3.0 to about pH 3.7, about pH 3.3 to about pH 3.7, and/or about pH 3.4 to about pH 3.6. For example, the target pH may be at about pH 3.0, about pH 3.1, about pH 3.2, about pH 3.3, about pH 3.4, about pH 3.5, about pH 3.6, about pH 3.7. Further, a target pH of the present fermentation reaction may be less than about pH 3.7, less than about pH 3.6, less than about pH 3.5, less than about pH 3.4, less than about pH 3.3, less than about pH 3.2, and less than about pH 3.1. Addition of the ACV to the mixture occurs during or after a “chill” process, which comprises, consists essentially of, or consists of rapidly cooling the mixture tank, and inherently cooling the contents within the cooling tank, in order to aid in the slowing and/or stopping of the fermentation reaction occurring in the mixture.

More specifically, the “chill” process cools the reaction to a temperature that is at, about, or below about 10° C., such as at, about, or at, about, or below 7° C. (i.e., 45° F. or below). In particular, the temperature during the chilling of the fermentation reaction may range from about 1° C. to about 10° C., about 1° C. to about 9° C., about 1° C. to about 8° C., about 1° C. to about 7° C., about 1° C. to about 6.5° C. about 1° C. to about 6° C., about 1° C. to about 5.5° C., about 1° C. to about 5° C., about 1° C. to about 4.5° C., about 1° C. to about 4° C., about 1° C. to about 3.5° C., about 1° C. to about 3° C., about 1° C. to about 2.5° C., about 1° C. to about 2° C., and from about 1° C. to about 1.5° C.

Chilling the fermentation reaction to a temperature that is within or around the target range (e.g., about 1° C. to about 10° C.) slows and/or stops the fermentation process. More specifically, chilling the fermentation reaction stops the reaction in a time period that ranges from about 3.5 hours to about 4.5 hours. In addition to the ACV, more lactic acid may be added to the mixture before, during, and/or after addition of the ACV to the mixture to form the non-dairy fermented water kefir base composition of the present disclosure.

Current processes of making non-dairy fermented water kefir base compositions have found challenges in standardizing the quality control necessary to replicate the amount and/or concentration of kefir grains required in the base composition. In addition, the standard fermentation process of producing kefir grains makes it extremely challenging to control batch-to-batch and/or lot-to-lot production variation of the base composition, which is desired for manufacturing and/or retail of nutritional products, such as food and/or beverage products comprising the base composition. However, embodiments of the present methods of making and/or fermenting the non-dairy water kefir of the present disclosure, provide the ability to control the microbial cell culturing and fermentation process in order to further control the output of the base composition without using water kefir grains at all.

A standard lactic acid fermentation process generally takes about 75 to about 120 hours to complete. However, the time to complete the processes of making, producing, and/or fermenting the base composition of the present disclosure range from about 2 hours to about 20 hours, from about 5 hours to about 20 hours, from about 10 hours to about 20 hours, from about 15 hours to about 20 hours, from about 12 hours to about 20 hours, from about 18 hours to about 20 hours, from about 14 hours to about 18 hours, from about 15 hours to about 17 hours, and less than about 20 hours. In further embodiments, the time period to complete the methods of making, producing, and/or fermenting the non-dairy water kefir base composition of the present disclosure may range from about 20 hours or less, and from about 8 to about 24 hours, from about 8 to about 22 hours, from about 8 to about 20 hours, from about 10 to about 22 hours, from about 10 to about 20 hours, from about 12 to about 18 hours, from about 14 to about 18 hours, from about 16 to about 18 hours, from about 15 to about 19 hours, and any time periods comprised therein. The average time period of the present fermentation and/or processing times are generally less than about 20 hours, and often closer to about 16±8, 16±6, 16±4, or 16±2 hours. In an illustrative embodiment, the fermentation processing time of the present methods is at or about 16 hours.

Therefore, the methods of the present disclosure advantageously shorten and/or reduce standard processing times, including the time for fermentation. More specifically, the present methods reduce the standard processing times of about 75 hours to about 120 hours by about 60-75% or more times. In particular, the processing time to produce the base composition of the present disclosure may be reduced by about 20%, about 30%, about 40%, about 50%, by about 60%, about 65%, about 70%, about 75%, about 80%, about 85%, about 90%, about 95%, about 96%, about 97%, about 98%, about 99%, or about 99.5% of the standard processing time for fermentation products.

The non-dairy fermented water kefir base composition of the present disclosure is produced by the combination of the starter culture and the medium (i.e., the mixture), as well as the acid (e.g., apple cider vinegar), and any optional/additional components. Once combined, the base composition may be included in food and/or beverage products for ingestion by subjects, such as humans. Accordingly, the present disclosure is also directed to a method of using the non-dairy fermented water kefir base composition of the present disclosure.

More specifically, a concentration ranging from about 2.5% to about 25% of the non-dairy fermented water kefir base composition of the present disclosure may be used to prepare food and/or beverage products, particularly food and/or beverage products for commercial retail. For example, from about 3% to about 20%, from about 4% to about 19%, from about 5% to about 18%, and from about 5% to about 17% of the non-dairy fermented water kefir base composition of the present disclosure may be used to prepare food and/or beverage products.

In particular, illustrative food and/or beverage products comprising the non-dairy fermented water kefir base composition may be in various forms, including, but not limited to food, snacks, elixirs, shots, shooters, spoonables, smoothies, shakes, soups, and beverages. Illustrative beverages in which the non-dairy fermented water kefir base composition of the present disclosure have been previously described and include, but are not limited to nutritional beverages, “organic” beverages, apple cider vinegar tonics (ACVTs), and sparkling probiotic drinks (SPDs), such as Kevita® brand products.

As mentioned, the present methods may comprise, consist essentially of, or consist of live yeast, live bacteria, and the combinations thereof. Illustrative embodiments of the methods for making and/or fermenting the non-dairy water kefir base composition do not require and/or use live yeast at all. In other words, in some embodiments of the present methods, only live bacteria are used.

Elimination of the use of live yeast prevents alcohol and/or ethanol production. In addition, omission of live yeast in the present methods also prevents the production of ethanol and eliminates product cross-contamination during the production and/or manufacturing process of food and/or beverage products for retail. These are unexpected benefits of the methods of making, fermenting, or using the base composition of the present disclosure.

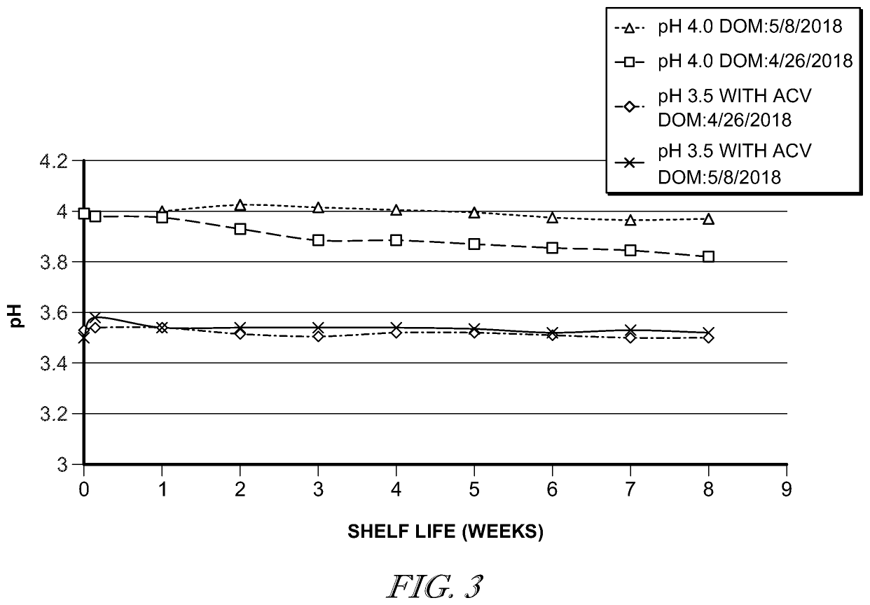

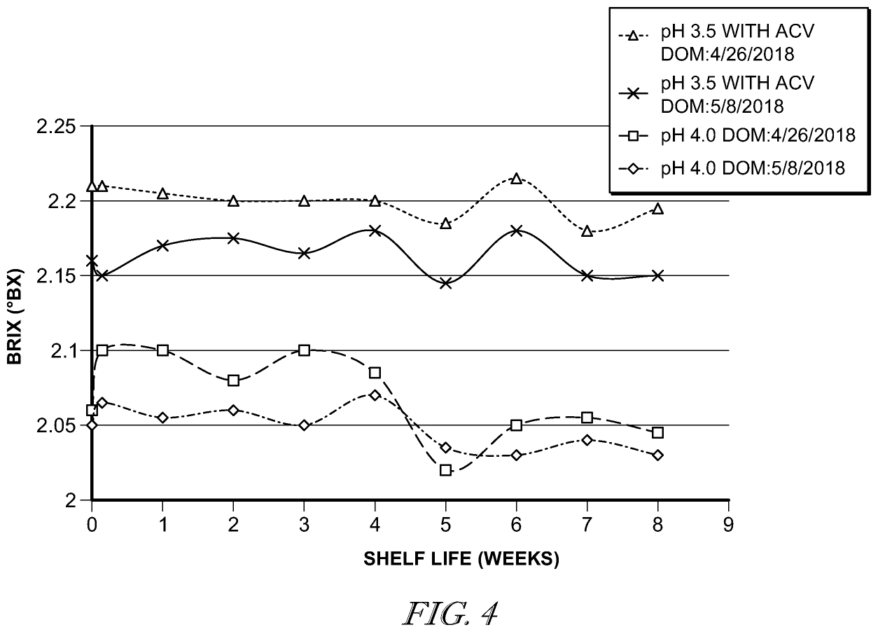

Further, the methods of making, fermenting, and/or using the non-dairy fermented water kefir base composition comprising the addition of apple cider vinegar provide an extension of shelf life or storage life of the resulting product, such as a food and/or beverage product. More specifically, an increased shelf/storage life is observed when the food and/or beverage product comprising the base composition is held at storage conditions comprising 7° C. or lower temperature (i.e., “chilled” storage). The current methods of making and/or fermenting the base composition provide an extension of storage time and/or shelf life to the food and/or beverage product that may last up to about 12 weeks (i.e., about 90 days). In particular, extension of storage time and/or shelf life of the food and/or beverage product of the present disclosure may range from about 8 weeks (i.e., about 60 days, see FIGS. 3 and 4), about 6 weeks (i.e., about 45 days), 4 weeks (i.e., about 30-31 days), about 2 weeks (i.e., 14-15 days), and/or about 1 week (i.e., about 7 days) longer than food and/or beverage products not prepared using the described methods.

Finally, the present methods of making, fermenting, and using the non-dairy fermented water kefir base composition of the present disclosure provide unexpected results as compared to the current method of fermentation. More specifically, the present methods of making, fermenting, and using the non-dairy fermented water kefir base composition of the present disclosure is less time consuming (i.e., by at least 60%) since it eliminates an extra filtration step to remove live yeast. This process does not have live yeast which eliminates the need to filter the final fermented product saving time and costs during manufacturing. Further, the present methods do not require expensive ingredients, but instead replace such high-cost ingredients and/or components with less expensive, but high quality components.

In addition, the claimed methods implement tighter process controls during production and manufacturing of the base composition. Moreover, the claimed process eliminates ethanol production, removal of live yeast, and cross-contamination that may occur from the use of live yeast, since the claimed methods do not require and/or use live yeast. Finally, the present disclosure is directed to new and improved methods and processes for fermenting water kefir grains that are capable of producing a non-dairy water kefir base composition, which may subsequently be used to generate food and beverage products with improved nutritional, sensory, flavor, and/or texture characteristics. Such qualities and characteristics are particularly important for the production of food and/beverage products for commercial retail.

### EXAMPLES

Illustrative embodiments of the compositions, components, and/or methods of the present disclosure are provided by way of examples. While the concepts and technology of the present disclosure are susceptible to broad application, various modifications, and alternative forms, specific embodiments will be described here in detail. It should be understood, however, that there is no intent to limit the concepts of the present disclosure to the particular forms disclosed, but on the contrary, the intention is to cover all modifications, equivalents, and alternatives consistent with the present disclosure and the appended claims. The following experiments were used to determine the effect of the improved processes for making and/or fermenting the non-dairy fermented water kefir composition of the present disclosure for use in food and/or beverage products, particularly food and/or beverage products for commercial retail.

### Example 1

### Ingredient Batching Before Pasteurization

The concentrated mash (i.e., a low-acid product) of the present disclosure may have the specifications described in Table 2 below:

TABLE 2

| | WATER KEFIR BASE CONCENTRATE MASH SPECS | | |
|---|---|---|---|
| | Target | Minimum | Maximum |
| TA, %* | 0.1 | 0.0 | 0.2 |
| Concentrate Brix @ 20° C. | 30.00 | 28.00 | 32.00 |
| (uncorrected) | | | |
| Alcohol, % v/v | 0 | — | 0.4 |
| pH | 6.0 | 5.8 | 6.2 |
| Shelf Life, chilled (LOW ACID), | 10-14 days | n/a, can use | [14 days] |
| in Totes | | per FS | |

| | |
|---|---|
| Pasteurization | Conditions based on pilot plant microthermics (HV): 1.5 L/min, 30 sec |
| | hold tube, 200-204° F. (target 202° F.). |
| | 205.6° F./2 min recommended to prevent growth of non-proteolytic C. bot. |
| | during the relatively short-time (14 days) refrigerated storage of the base. |
| Micro testing | Micro clearance at this stage ensures nothing is interfering with the |
| | fermentation process. |
| Critical specs | Specs monitored each batch. Brix must be correct to continue (could |
| | adjust in ferment tank). |

### Example 2

### Ferment Tank Filling, Single Strength Method

Dilution of concentrated mash with RO water to reconstituted single strength is described in Table 3 below. In particular, single strength mash equals 1 part MASH to 14 Parts RO water, which totals about 6.66% MASH and 93.33% water (see Table 1 above).

TABLE 3

| | WATER KEFIR BASE SINGLE STRENGTH-BEFORE FERMENTATION SPECS | | |
|---|---|---|---|
| | Target | Minimum | Maximum |
| TA, %* | 0.01 | 0.0 | 0.1 |
| Single Strength Brix @ 20° C. | 2.1 | 2 | 2.4 |
| (uncorrected) | | | |
| Alcohol, % v/v | 0 | — | 0.4 |
| pH (Initial, prior to culture addition) | 6.5 | 6.2 | 6.6 |
| Temperature maintained at | 36° C. | 34° C. | 38° C. |
| 36° C. ± 2° C. | (97° F.) | (93° F.) | (100° F.) |

| | |
|---|---|
| Micro testing | Before fermentation this is still a low-acid product. |
| | No sampling/testing required, ensure tank is clean prior to filling. |
| Critical specs | Specs monitored. Brix, Temperature must be correct (prior to culture addition). |

### Example 3

### Starter Culture (e.g., Chr. Hansen YF-L02) Addition to Tank

The usage rate of the Chr. Hansen starter culture was 0.011% w/w (see Table 1 above). The inoculation rate of the starter cultures is shown in Table 4 below. Each bag of starter culture is about 500 units (U)=1 bag per 4000 L batch, which equates to approximately 500 g of active culture. This includes a slight over inoculation, but this over inoculation should not have a detrimental impact on the fermentation efficiency or productively. The dosage of starter culture frozen pellets should be added from the top with the tank partially filled. Thawing of starter culture prior to addition to the tank is not necessary.

Culture bags may be sanitized prior to opening the bag. In a preferred embodiment, bags must be sanitized before opening the bag to prevent cross-contamination. The bag opening should also be dry prior to opening the culture to ensure no residual sanitizer is present.

The starter culture should be added when the tank is a quarter filled with the water/mash at single strength, which allows for proper thawing and distribution of the culture. Alternatively, the starter culture could be added after the tank is filled. However, there is risk of inadequate distribution and clumping of the frozen starter culture leading to extended or halted fermentation times in this method embodiment. In either case, appropriate mixing of the culture and water at this stage is desired.

The water/mash single-strength mixture should be at proper temperature prior to starter culture addition. The brix of the mixture can be adjusted to be within specifications after addition of starter culture, if necessary. However, fermentation time will have started once the starter culture is added to the water. Monitoring of the inoculation rate during start-up is helpful, but may be switched to periodic monitoring once the fermentation process is consistent.

TABLE 4

| | | | |
|---|---|---|---|
| Inoculation rate (monitor | 6*10\hat{ }6 ± 0.5 | High 10\hat{ }5 | High 10\hat{ }7 |
| during start-up) | log | | |

### Example 4

### In-Process Ferment Tank During Cycle

The tank should have continuous pH monitoring and acidification curves/rates may be recorded for each batch to enable tracking fermentation consistency and to effectively troubleshoot should a deviation arise. The fermentation curves may be stored to generate a database on historical rates of acidification. If correct pH is not reached in time, one needs to evaluate fermentation to ensure nothing is wrong by assessing the following parameters:
Temperature is correct: 36° C.±2° C.
Inoculation rate correct: 6*10̂6±0.5 log.
Mash/water ratio correct: Initial Brix 2.0-2.4.
Critical specs correct and no contamination during culture addition.

TABLE 5

| | |
|---|---|
| Critical specs | Time to reach pH 4.6 is 4 hrs ± 30 minutes. |
| | Time to reach final target pH 4.0 is 16 ± 2 hrs. |
| Note on Phage: | Incorporation of different control measures can be |
| Viruses that infect | taken to mitigate the risk of an infection being |
| bacterial cells: | detrimental to the fermentation: use of closed |
| low risk for this | vessels, raw ingredient treatment, CIP). |
| batch process of | Bacteria Phage testing: Initially samples may be |
| non-dairy | sent off to gather initial data. If data is |
| fermentations | consistent with low to no levels of phage detected |
| | can extend testing to monthly or quarterly. |

### Example 5

### Ferment Tank At End of Cycle

Intermediate fermented ingredient/product specification should be assessed after the fermentation process is over, which equates to once the pH reaches 4.0±0.1. The chill tank may be placed at 38-41° F. prior to adding apple cider vinegar to stop fermentation as described in Table 6 as follows:

TABLE 6

| | WATER KEFIR BASE 2.0 - FERMENTED SPEC PRIOR to addition of Apple Cider Vinegar | | |
|---|---|---|---|
| | Target | Minimum | Maximum |
| TA, %* | 0.03 | 0 | 0.1 |
| Brix @ 20° C. (uncorrected) | 2.1 | 1.8 | 2.50 |
| Alcohol, % v/v | <0.40 | — | 0.40 |
| pH target to stop fermentation | 4.0 | 3.9 | 4.1 |
| reaction | | | |
| Time to reach final target pH | 16 ± 2 hrs | 14 | (pH stable 24 h) |

Temperature maintained at 36° C. ± 2° C. during fermentation, then chilled to 4° C. (35-40° F.,
<45° F.) to stop ferment.

| | |
|---|---|
| Micro testing | Not required prior to ACV addition. |
| Critical specs | Specs monitored each batch. Time to reach target pH should be accurate and |
| | pH must be correct before ACV is added. |

### Example 6

### Addition of Apple Cider Vinegar (ACV) into Tank

The amount of ACV to be finalized during start-up is based on unit size in order to reach a target pH of 3.5±0.1. The actual amount of ACV may have an impact on the organic nature and sensory impact of food and/or beverage products.

TABLE 7

| | | | |
|---|---|---|---|
| % of Apple Cider Vinegar | Target to add less, | 3.75% | 5.5% |
| added (w/w) | then check pH | | |

Final product specification after the fermentation process is over and after addition of Apple Cider Vinegar (ACV) will likely be as described in Table 8 below:

TABLE 8

| | WATER KEFIR BASE FINAL SPEC w/ACV | | |
|---|---|---|---|
| | Target | Minimum | Maximum |
| TA, % Lactic | 0.3 | 0.2 | 0.4 |
| Brix @ 20° C. (uncorrected) | 2.2 | 2.0 | 2.50 |
| Alcohol, % v/v* | <0.40 | — | 0.40 |
| pH | 3.50 | 3.4 | 3.6 |

| | |
|---|---|
| Micro testing | Pending tank hold time. |
| Critical specs | pH following ACV addition, if decreases beyond 3.4 and chilled, then live |
| | culture may be growing. |

Notably, the Apple Cider Vinegar (ACV) adds a small amount of alcohol. Thus, a user may only monitor alcohol at the final specs since the ACV will be the only source of alcohol in the mixture. Accordingly, incoming ACV material should be pasteurized and correct specification on incoming ingredients should be considered.

### Example 7

### Shelf Life and Storage of Base Composition

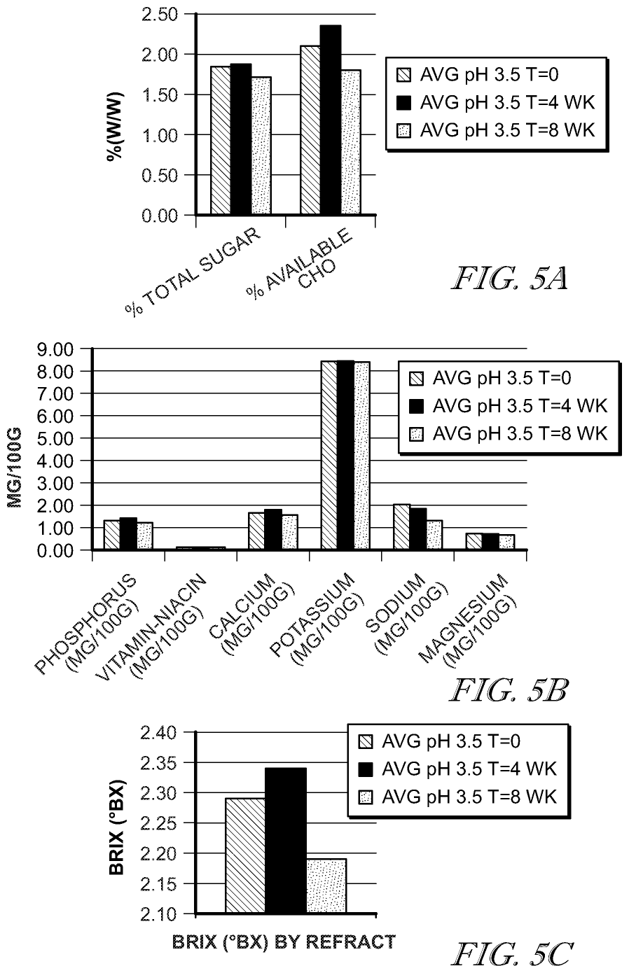

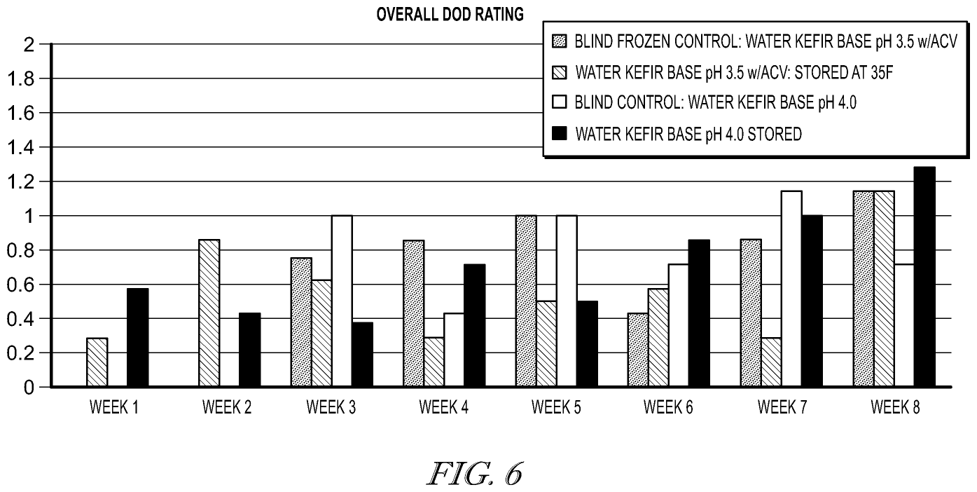

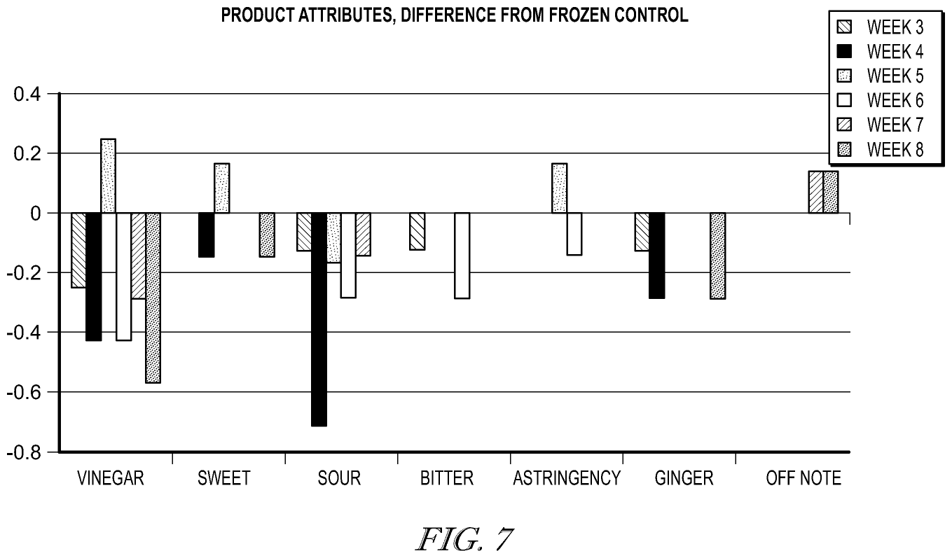

As shown in Examples 1-6, analysis and investigation of the shelf life and storage requirements provided by the base composition of the present disclosure to food and/or beverage products showed no observed changes in the degrees of Brix, pH, Titratable acidity (TA), shelf life, storage, sensory, and/or nutritional performance characteristics (see Table 9) or features when the base composition was store chilled (i.e., about 4° C. or so) for up to 8 weeks (see FIGS. 3-5). In fact, the chilled and stored (“chill stored”) base composition was no different than the frozen control base composition for up to 8 weeks of storage at about 0° C. to about 4° C. (see Table 11 and FIGS. 6 and 7).

However, after 8 weeks of storage, some adverse effects were observed in the base composition. For example, conversion of sucrose into glucose and fructose was observed. In addition, there was a decrease in sodium or salt. Further, there were some slight color changes observed for the base composition after 8 weeks of storage.

Notably “BQL” stands for below quantifiable limit or level to detect that specific compound therefore a minimal level may be present but is unable to be quantified with method accuracy.

### Example 8

### Microbial Contamination of Base Composition

The base composition of the present disclosure was also tested for prevention of microbial detection (see Table 10 below). Twelve ounce polyethylene (PET) bottles comprising the non-dairy water kefir base composition having a pH of 4.0 and 3.5 were induction sealed. The bottles comprising the base composition were stored for 7 weeks and 5 weeks, respectively. The anaerobic base compositions were compared to a anaerobic base control plate. The base compositions were tested for yeast, mold, coliforms, and E. coli. In all of the base composition embodiments, less than 1 CFU/g of yeast, mold, coliforms, and/or E. coli was detected after 7 weeks of storage. Accordingly, the base composition of the present disclosure showed no microbial contamination for up to 7 weeks.

### Example 9

### Storage Temperature Impact on Base Composition Performance

Different storage temperatures were also tested to determine the impact of temperature on the performance of the non-dairy water kefir base composition of the present disclosure. Storage temperatures ranging about −15° C. to about 34° C. were tested. More specifically, temperatures of about −17.7° C. (i.e., 0° F.), about 1.7° C. (i.e., 35° F.), about 12.8° C. (i.e., 55° F.), about 23.9° C. (i.e., about 75° F.), and at about 32.2° C. (i.e., 90° F.) used for storage at or up to about 8 weeks were investigated to determine the impact on the performance of the base composition.

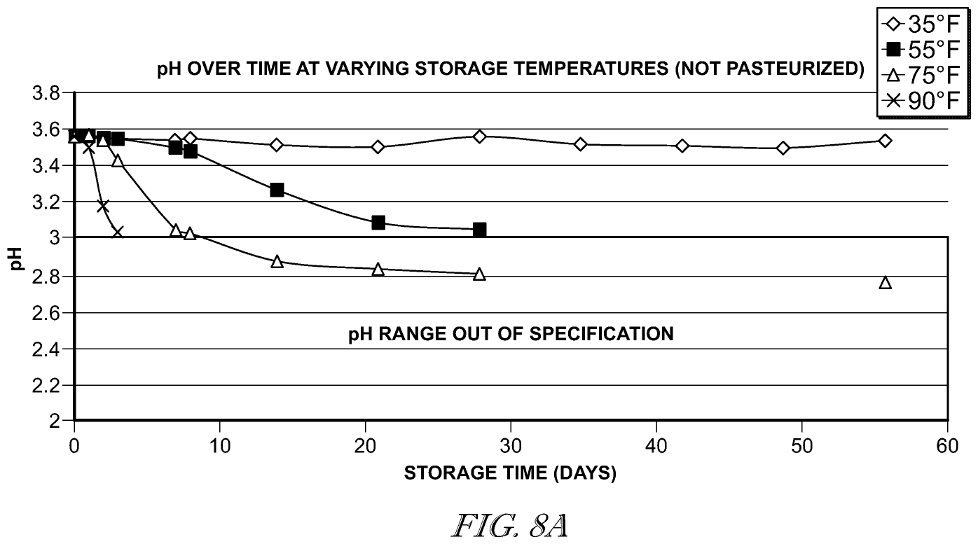

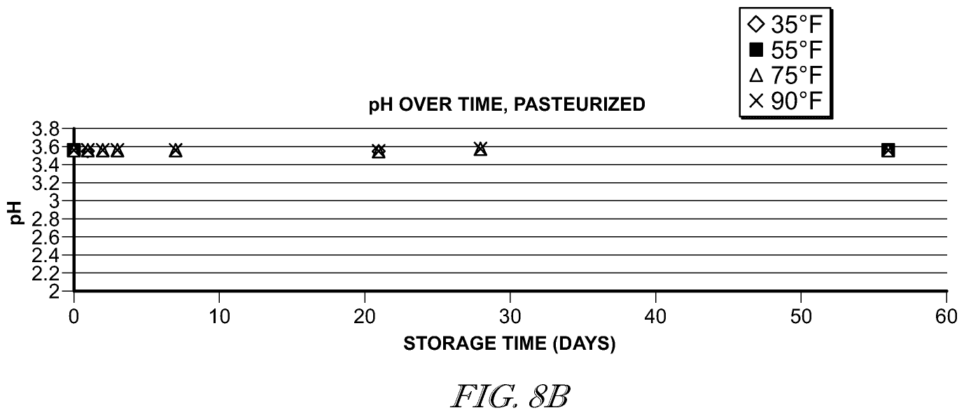

Notably, when temperatures rose higher than about 1.7° C. (i.e., 35° F.), this significantly affected the pH such that the base composition did not have the proper specifications and/or characteristics. Thus, a maximum temperature of about 1.7° C. (i.e., 35° F.) is desired. Correspondingly, base compositions with a pH of 3.56 or lower seemed to provide increased shelf life for up to about 56 days when stored at about 1.7° C. (i.e., 35° F.) or lower (see Table 11 and FIGS. 8A and 8B). Thus, the data provided in Table 11 shows that the maximum shelf life was correlated to and/or dependent on the temperature and pH of the base composition.

TABLE 9
Average T = 0 Nutritional profiles
form three different pilot plant productions:

| | | |
|---|---|---|
| Basic Analytical | pH | 3.56 |
| | Titratable Acidity (lactic) | 0.31 |
| | Brix by Refract | 2.29 |
| | % Moisture | 97.80 |
| | Density (g/mL) | 1.0072 |
| | Residual Ethanol (%) | 0.03 |
| | Color by Hunter | |
| | L* | 96.68 |
| | a* | −0.49 |
| | b* | 6.13 |
| Sugar Profile | % Fructose | BQL |
| | % Glucose | BQL |
| | % Sucrose | 1.85 |
| | % Maltose | BQL |
| | % Lactose | BQL |
| | % Total | 1.85 |
| mg/100 g Organic Acids | Citric Acid | BQL |
| | Malic Acid | BQL |
| | Acetic Acid | 204.00 |
| | Tartaric Acid | BQL |
| | Succinic Acid | BQL |
| | Formic Acid | BQL |
| | Lactic Acid | 130.00 |
| Nutritional Profile | % Available CHO | 2.10 |
| | Calories/100 g | 8.90 |
| | Phosphorus (mg/100 g) | 1.32 |
| | Vitamin-Niacin (mg/100 g) | 0.05 |
| | Calcium (mg/100 g) | 1.66 |
| | Potassium (mg/100 g) | 8.43 |
| | Sodium (mg/100 g) | 2.04 |
| | Magnesium (mg/100 g) | 0.74 |
| Nutritional Profile (BQL) | Ash by TGA | BQL |
| | % Protein <0.2% | 0.14 |
| | Fat | BQL |
| | Copper by ICP | BQL |
| | Iron by ICP | 0.05 |
| | Vitamin-Pantothenic acid | 0.14 |
| | (mg/100 g) | |
| | Vitamin-Riboflavin | BQL |
| | (mg/100 g) | |
| | Vitamin-Thiamine (mg/100 g) | 0.01 |
| | Vitamin B6 (Pyridoxine | BQL |
| | Hydrochloride) | |
| | Vitamin B12 | BQL |

TABLE 10

| | | | | | |
|---|---|---|---|---|---|
| | Aerobic | | | | |
| | Plate | | | | |
| | Count | Yeast | Mold | Coliforms | E. coli |
| | (SPC) | (PDA) | (PDA) | (Petri film) | (Petrifilm) |
| Sample Description | CFU/g | CFU/g | CFU/g | CFU/g | CFU/g |

| | | | | |
|---|---|---|---|---|
| Water Kefir BASE pH 4.0 | <1 | <1 | <1 | <1 |
| 5 wk DOM | | | | |
| Water Kefir BASE | <1 | <1 | <1 | <1 |
| pH 3.5 w/ACV 5 wk DOM | | | | |
| Water Kefir BASE pH 4.0 | <1 | <1 | <1 | <1 |
| 7 wk DOM | | | | |
| Water Kefir BASE w/ACV | <1 | <1 | <1 | <1 |
| pH 3.5 7 wk DOM | | | | |

TABLE 11

| | pH over time, RAW/Not pasteurized | | | | | |
|---|---|---|---|---|---|---|
| Days | 0° F. | 35° F. | 55° F. | 75° F. | 90° F. | |
| 0 | 3.56 | 3.56 | 3.56 | 3.56 | 3.56 | |
| 1 | | 3.55 | 3.56 | 3.57 | 3.5 | max shelf |
| | | | | | | life @ 90° F. |
| 2 | | | 3.55 | 3.54 | 3.18 | |
| 3 | | | 3.55 | 3.43 | 3.04 | max shelf |
| | | | | | | life @ 75° F. |
| 7 | | 3.54 | 3.5 | 3.05 | | |
| 8 | | | 3.48 | 3.03 | | max shelf |
| | | | | | | life @ 55° F. |
| 14 | | 3.515 | 3.27 | 2.88 | | |
| 21 | | 3.505 | 3.09 | 2.84 | | |
| 28 | | 3.56 | 3.05 | 2.81 | | |
| 35 | | 3.52 | | | | |
| 42 | | 3.51 | | | | |
| 49 | | 3.5 | | | | |
| 56 | | 3.54 | | 2.76 | | |

### Example 10

### Improvement of Processing/Fermenting Time

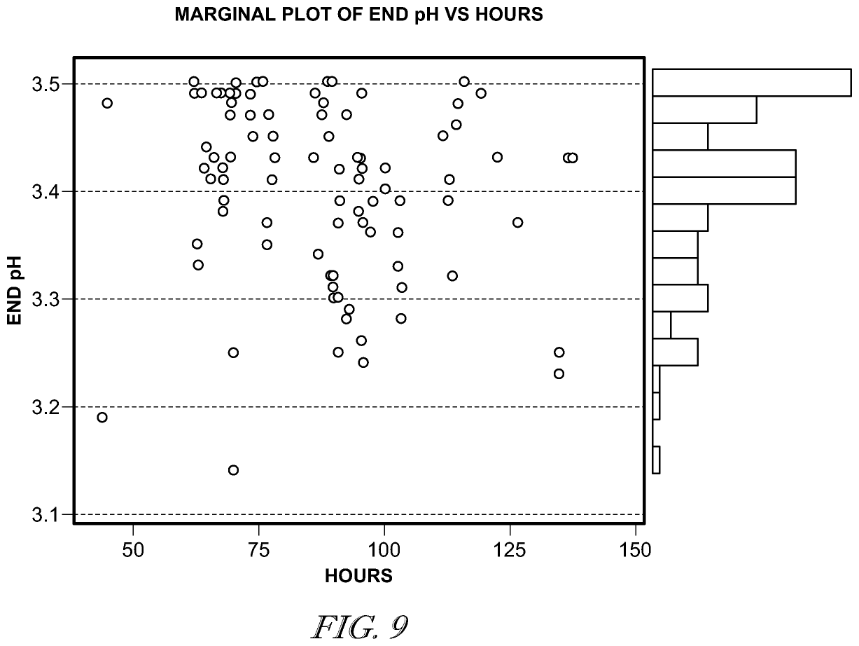

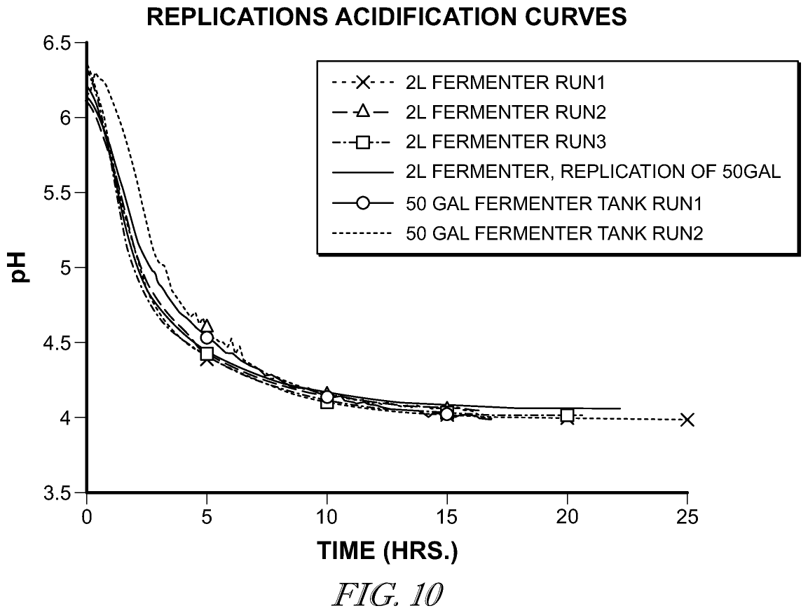

This final example is provided to demonstrate the improvement in making, producing, and/or fermenting the base composition of the present disclosure as compared to methods known in the art. More specifically, FIG. 9 demonstrates that prior art methods to produce a water kefir base composition without the addition of apple cider vinegar (i.e., acetic acid) and/or lactic acid required approximately 75-100 hours to drive the pH below 3.5-4.0. However, the data of FIG. 10 demonstrates that the current improved method of producing and/or fermenting the base composition of the present disclosure only requires about 10 to about 20 hours, and often about 16 hours±2 hours (i.e., 14 to about 18 hours) in order to drive the pH to about 4.0, and preferably even lower (e.g., pH 3.5 or so). In addition, the current method of producing and/or fermenting the base composition does not require any filtration of live yeast, since live yeast are not required for the current method. Additionally, the current method provides consistency across batches and lots of the base composition, which is required for commercial quality control. Accordingly, the present method of producing and/or fermenting the base composition of the present disclosure provided a significant advantage in the 60-75% or more reduction of processing time to obtain the base composition.

The preceding description enables others skilled in the art to use the technology in various embodiments and with various modifications as are suited to the particular use contemplated. In accordance with the provisions of the patent statutes, the principles and modes of operation of this disclosure have been explained and illustrated in exemplary embodiments. Accordingly, the present invention is not limited to the particular described and/or exemplified embodiments.

It is intended that the scope of disclosure of the present technology be defined by the following claims. However, it must be understood that this disclosure may be practiced otherwise than is specifically explained and illustrated without departing from its spirit or scope. It should be understood by those skilled in the art that various alternatives to the described embodiments may be used in practicing the claims without departing from the spirit and scope as defined in the following claims.

The scope of this disclosure should be determined, not only with reference to the above description, but should be determined with reference to the appended claims, along with the full scope of equivalents to which the claims are entitled. It is anticipated and intended that future developments will occur, and that the disclosed compositions and methods will be incorporated into those future developments.

Furthermore, all terms used in the claims are intended to be given their broadest reasonable construction and their ordinary meaning as understood by those skilled in the art unless an explicit indication to the contrary is made. In particular, use of the singular articles such as “a,” “the,” “said,” etc. should be read to recite one or more of the indicated elements unless a claim recites an explicit limitation to the contrary. It is intended that the following claims define the scope of the disclosure and that the technology within the scope of these claims and their equivalents will be covered. In sum, it should be understood that the disclosure is capable of modification and variation and is limited only by the following claims.

We claim:

1. A non-dairy fermented water kefir base composition comprising:
a. a mash,
b. a starter culture,
c. a medium, and
d. an organic acid.

2. The composition of claim 1, wherein the starter culture comprises live yeast, live bacteria, or combinations thereof.

3. The composition of claim 2, wherein the starter culture comprises live bacteria only.

4. The composition of claim 1, wherein the medium is a liquid medium.

5. The composition of claim 4, wherein the liquid medium is water.

6. The composition of claim 5, wherein the water comprises a source of a carbon, a nitrogen, and a mineral.

7. The composition of claim 1, wherein the organic acid is selected from the group consisting of acetic acid, lactic acid, citric acid, fumaric acid, phosphoric acid, malic acid, oxalic acid, ascorbic acid, and combinations thereof.

8. The composition of claim 7, wherein the acetic acid is in the form of apple cider vinegar.

9. The composition of claim 8, wherein the apple cider vinegar comprises from about 0.1% to about 6% of the non-dairy fermented water kefir base composition.

10. A nutritional product comprising the non-dairy fermented water kefir base composition of claim 1.

11. The nutritional product of claim 10, wherein the nutritional product is a food, a snack, an elixir, a shot, a shooter, a spoonable, a smoothie, a shake, a soup, or a beverage.

12. A method of producing a non-dairy fermented water kefir base composition comprising:
a. mixing a starter culture and a medium to form a mixture,
b. fermenting the mixture to produce an amount of lactic acid,
c. adding an organic acid that is not the lactic acid to the mixture at a pH ranging from about 3.5 to about 4.2, and
d. producing the non-dairy fermented water kefir base composition.

13. A method of fermenting a non-dairy fermented water kefir base composition comprising:
a. mixing a starter culture and a medium to form a mixture,
b. producing an amount of lactic acid from the mixture until the pH ranges from about 3.5 to about 4.2,
c. cooling the reaction to stop production of the lactic acid, and
d. adding an organic acid that is not the lactic acid to the mixture so that the pH ranges from about 3.0 to about 3.6.

14. The composition of claim 1, wherein the mash comprises a component selected from the group consisting of water, a sugar source, a mineral blend, and one or more enhancers.

15. The composition of claim 14, wherein the one or more enhancers are selected from the group consisting of a flavoring agent, a yeast extract, a fruit syrup, an herb or botanical extract, and a salt.

16. The method of claim 14, wherein addition of the organic acid that is not lactic acid also increases the titratable acidity of the base composition by 50-200%.

17. The method of claim 15, wherein addition of the organic acid that is not lactic acid also increases the titratable acidity of the base composition by 50-200%.
